(19) United States
(12) Patent Application Publication
(10) Pub. No.: US 2024/0328580 A1
(43) Pub. Date: Oct. 3, 2024

(54) GAS CYLINDER FRAME AND TRANSPORTATION MECHANISM

(71) Applicant: GCE Group AB, Malmo (SE)

(72) Inventors: Gareth Pemberton, Worcester (GB); Mark Webster, Norfolk (GB); Antoon DeBruijn, Norfolk (GB)

(21) Appl. No.: 18/732,765

(22) Filed: Jun. 4, 2024

Related U.S. Application Data
(63) Continuation of application No. PCT/IB2022/061839, filed on Dec. 6, 2022.
(60) Provisional application No. 63/286,618, filed on Dec. 7, 2021.

(51) Int. Cl. F17C 13/08; B62B 3/06; B62B 3/10

(52) U.S. Cl. CPC F17C 13/085; B62B 3/0643; B62B 3/104; B62B 2202/022; B62B 2203/44; F17C 2201/0109; F17C 2205/0107; F17C 2205/0142; F17C 2205/0146; F17C 2205/0161; F17C 2205/0326; F17C 2205/0338; F17C 2227/042; F17C 2250/032

(57) ABSTRACT

A gas cylinder holder may include a frame that defines a storage region for receiving multiple gas cylinders. The gas cylinders disposed within the storage region may be coupled to an outlet cabinet of the gas cylinder holder that contains components configured to output/deliver gas from the gas cylinders. The gas cylinder holder may further include a control panel configured to control the outlet cabinet components in order to dictate the gas cylinder from which the gas is delivered. The frame of the gas cylinder holder may further include at least one engagement member. A cart or other transportation mechanism may be configured to engage with the at least one engagement member of the frame of the gas cylinder holder to facilitate lifting and moving the gas cylinder cart regardless of whether or not gas cylinders are disposed within the storage region of the gas cylinder holder.

### CROSS-REFERENCE TO RELATED APPLICATIONS

This patent application is a continuation application of and claims priority under 35 U.S.C 120 to International Application No. PCT/IB2022/061839, filed Dec. 6, 2022, entitled “Gas Cylinder Frame and Transportation Mechanism”, which in turn claims priority to and the benefit of U.S. Patent Application No. 63/286,618, filed Dec. 7, 2021, entitled “Gas Cylinder Frame and Transportation Mechanism”. The entire disclosure of each of the above-identified two patent applications is incorporated herein by reference.

### TECHNICAL FIELD

The present invention relates generally to a gas cylinder holder and gas cylinder cart, and in particular, to a gas cylinder holder adapted to facilitate operation of one or more gas cylinders when installed in the gas cylinder holder, and a gas cylinder cart that facilitates transportation of the gas cylinder holder with or without gas cylinders installed on the gas cylinder holder.

### BACKGROUND OF THE INVENTION

Gas cylinders are heavy and difficult to move and reposition. Gas cylinders have a limited amount of volume and from time-to-time, need to be replaced. Usually the replacement of a gas cylinder in a system results in the interruption of service and the flow of gas.

There is a need for a gas cylinder holder that can securely and safely support gas cylinders during operation and transportation. In addition, there is a need for a gas cylinder cart or trolley that can easily lift and transport a gas cylinder holder and any gas cylinders supported by the gas cylinder holder.

### SUMMARY OF THE INVENTION

The present invention relates to a gas cylinder system. In one embodiment, the gas cylinder system has a gas cylinder holder or frame that includes a base frame member on which a gas cylinder can be placed, a first upstanding frame member coupled to a first side of the base frame member, the first upstanding frame member having a first engagement member extending outwardly from the first upstanding frame member and defining a first receiving region with the first upstanding frame member, the first upstanding frame member including a plurality of hinge members spaced apart vertically from each other, a second upstanding frame member coupled to a second side of the base frame member, the second side of the base frame member being opposite the first side of the base frame member, the second upstanding frame member having a second engagement member extending outwardly from the second upstanding frame member and defining a second receiving region with the second upstanding frame member, the second engagement member extending in a direction opposite to the direction of the first engagement member, a first rear horizontal member extending from the first upstanding frame member to the second upstanding frame member, a second rear horizontal member extending from the first upstanding frame member to the second upstanding frame member, an electronic component coupled to one of the first rear horizontal member and the second rear horizontal member, and a door rotatably mounted to the first upstanding frame member, the door including a first front horizontal member having a hinge member coupled to one of the plurality of hinge members on the first upstanding frame member, a second front horizontal member spaced apart from and parallel to the first front horizontal member, a third front horizontal member being spaced apart from and parallel to the second front horizontal member, the third front horizontal member having a hinge member coupled to a different one of the plurality of hinge members on the first upstanding frame member, a front vertical member coupled to two of the front horizontal members, and a control panel coupled to one of the horizontal members or the vertical members of the door, wherein the door pivots between an opened position and a closed position about an axis passing through each of the hinge members.

In one embodiment, the first engagement member includes a horizontal member and a vertical member coupled to the horizontal member of the first engagement member, and the vertical member and the horizontal member of the first engagement member collectively define the first receiving region with the first upstanding frame member. In one embodiment, the base frame member, the first upstanding frame member, the second upstanding frame member, the first rear horizontal member, the second rear horizontal member, and the door collectively define a storage region in which one or more gas cylinders can be placed. In addition, each of the electronic component and the control panel can be used in the operation of a gas cylinder placed in the storage region.

In another embodiment, the gas cylinder system has a gas cylinder placed on the base frame member, wherein the upstanding frame members are located on opposite sides of the gas cylinder, the rear horizontal members are located on a rear side of the gas cylinder, and the door is located on a front side of the gas cylinder. The system includes a tether having a first end and a second end opposite the first end, wherein the first end of the tether is coupled to the first rear horizontal member, the second end of the tether is coupled to the first upstanding frame member, and the tether extends around a portion of the gas cylinder. In addition, the first end of the tether is fixedly coupled to the first rear horizontal member, and the second end of the tether is releasably coupled to the first upstanding frame member. Also, the first receiving region is configured to receive a first lift arm on a gas cylinder cart, the second receiving region is configured to receive a second lift arm on the gas cylinder cart, and the gas cylinder holder can be lifted so that the base frame member is raised off a support surface when the first lift arm and the second lift arm move the first receiving region and the second receiving region upwardly respectively.

In another embodiment, the second upstanding frame member includes a first latch mechanism, and the first front horizontal member includes a second latch mechanism that is engageable with the first latch mechanism to retain the door in its closed position. Alternatively, the electronic component is mounted to the first rear horizontal member and to the second rear horizontal member, and the control panel is mounted to the first front horizontal member.

In a different embodiment of the invention, a gas cylinder cart has a movable frame includes a lower frame including a plurality of mobility devices coupled thereto, a first upstanding rear frame member coupled to and extending upwardly from the lower frame, a second upstanding rear frame member coupled to and extending upwardly from the lower frame, a first side upper frame member coupled to and extending from the first upstanding rear frame member, and a second side upper frame member coupled to and extending from the second upstanding rear frame member, and a lifting mechanism coupled to the movable frame, the lifting mechanism comprising a first lifting device including a first lower component and a first upper component coupled to and movable relative to the first lower component, the first upper component being configured to engage a first receiving region on a gas cylinder holder, a second lifting device including a second lower component and a second upper component coupled to and movable relative to the second lower component, the second upper component being configured to engage a second receiving region on the gas cylinder holder, and an actuator pivotally coupled to the movable frame, wherein the actuator is engageable with each of the first lifting device and the second lifting device, and the actuator is movable between a lowering position and a lifting position.

In an alternative embodiment, the lower frame comprises a rear lower frame member, a first side lower frame member coupled to the rear lower frame member, and a second side lower frame member coupled to the rear lower frame member, and each of the plurality of mobility devices is coupled proximate to one of the rear lower frame member, the first side lower frame member, and the second side lower frame member.

In another embodiment, the actuator has a first actuator end and a second actuator end opposite to the first actuator end, each of the first actuator end and the second actuator end is coupled to the movable frame, the first actuator end has a first cam member coupled thereto that is engageable with the first lifting device, and the second actuator end has a second cam member coupled thereto that is engageable with the second lifting device. In addition, the first lifting device includes a lower component and an upper component that moves relative to the lower component between a lowered position and a raised position, and the second lifting device includes its own lower component and its own upper component that moves relative to its lower component between its own lowered position and its own raised position, the first cam member causes the first lifting device upper component to move between its lowered position and its raised position, and the second cam member causes the second lifting device upper component to move between its lowered position and its raised position.

Alternatively, the movable frame includes a first handle coupled to the first upstanding rear frame member and a second handle coupled to the second upstanding rear frame member, and the handle can be used to move the movable frame on the mobility devices along a support surface.

In a different embodiment of the invention, a gas cylinder system includes a gas cylinder, a gas cylinder holder configured to receive and support the gas cylinder, the gas cylinder holder including a base frame member, a plurality of upstanding frame members coupled to the base frame member, each of the plurality of upstanding frame members having an engagement member defining a receiving region, a rear horizontal member extending between the plurality of upstanding frame members, a control cabinet coupled to the rear horizontal member and connectable with the gas cylinder, and a door coupled to one of the upstanding frame members, the door being rotatable between an opened position and a closed position, the door, the base frame member, the plurality of upstanding frame members, and the rear horizontal member collectively defining an area in which the gas cylinder can be located, and a gas cylinder cart comprising a lower frame including a plurality of mobility devices coupled thereto, the plurality of mobility devices being translatable across a support surface, an upper frame mounted to the lower frame, the upper frame including a plurality of upstanding rear frame members coupled to the lower frame, and a plurality of side upper frame members, each of the plurality of side upper frame members is coupled to one of the plurality of upstanding rear frame members, and a lifting mechanism coupled to the upper frame, the lifting mechanism being configured to engage the receiving region of each of the plurality of upstanding frame members, the lifting mechanism including an actuator that can be moved between a lifting position and a lowered position, the actuator causing the lifting mechanism to raise the gas cylinder holder and the gas cylinder when the actuator is moved to its lifting position.

In an alternative embodiment, the lifting mechanism includes a first lifting device on a first side of the upper frame and a second lifting device on a second side of the upper frame, the actuator is engageable with the first lifting device and with the second lifting device to move them between lowered positions and raised positions, and the gas cylinder holder and the gas cylinder are raised off a support surface when the first lifting device and the second lifting device are engaged with the receiving regions and are in their raised positions.

In another embodiment, the plurality of upstanding frame members includes a first upstanding frame member and a second upstanding frame member, the engagement member of the first upstanding frame member extends outwardly in a first direction, the engagement member of the second upstanding frame member extends outwardly in a second direction, and the second direction being opposite to the first direction. Also, the gas cylinder is a first gas cylinder, the gas cylinder system further comprises a second gas cylinder, and the gas cylinder holder further comprises a first tether coupled to the rear horizontal member, extending around the first gas cylinder, and being releasably coupled to the first upstanding frame member, and a second tether coupled to the rear horizontal member, extending around the second gas cylinder, and being releasably coupled to the second upstanding frame member.

Alternatively, the door includes a first front horizontal member, a second front horizontal member spaced apart from and parallel to the first front horizontal member, a third front horizontal member spaced apart from and parallel to the second front horizontal member, a first front vertical member coupled to the first front horizontal member and to the second front horizontal member, a second front vertical member coupled to the second front horizontal member and to the third front horizontal member, and a control panel coupled to one of the horizontal members or the vertical members of the door.

### BRIEF DESCRIPTION OF THE DRAWINGS

The apparatuses, systems, devices, modules, and/or components presented herein may be better understood with reference to the following drawings and description. It should be understood that some elements in the figures may not necessarily be to scale and that emphasis has been placed upon illustrating the principles disclosed herein.

FIG. 1 illustrates a front perspective view of gas cylinder holder in accordance with an example embodiment of the present invention.

FIG. 2 illustrates another front perspective view of the gas cylinder holder illustrated in FIG. 1.

FIG. 2A illustrates a top view of a few components of the gas cylinder holder illustrated in FIG. 1.

FIG. 3 illustrates a rear perspective view of the gas cylinder holder illustrated in FIG. 1.

FIG. 4 illustrates a front view of the gas cylinder holder illustrated in FIG. 1.

FIG. 5 illustrates a rear view of the gas cylinder holder illustrated in FIG. 1.

FIG. 6 illustrates a side view of the first side of the gas cylinder holder illustrated in FIG. 1.

FIG. 7 illustrates a side view of the second side of the gas cylinder holder illustrated in FIG. 1.

FIG. 8 illustrates an interior view of the outlet cabinet or electronic component of the gas cylinder holder illustrated in FIG. 1.

FIG. 9 illustrates a front view of the upper portion of the gas cylinder holder illustrated in FIG. 1 where the control panel is shown.

FIG. 10 illustrates a flowchart of an exemplary process for replacing a cylinder in the gas cylinder holder illustrated in FIG. 1.

FIG. 11 illustrates a flowchart of an exemplary vent process for replacing a cylinder in the gas cylinder holder illustrated in FIG. 1.

FIG. 12 illustrates a rear perspective view of a gas cylinder cart in accordance with an example embodiment of the present invention, the gas cylinder cart engaging the gas cylinder holder illustrated in FIG. 1 and the lifting handle of the gas cylinder cart being oriented in its lowered position.

FIG. 13 illustrates a front perspective view of the gas cylinder cart illustrated in FIG. 12, with the lifting handle being oriented in its raised position.

FIG. 14 illustrates a side view of an end of the lifting handle of the gas cylinder cart illustrated in FIG. 12.

### DETAILED DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The terms “comprising,” “including,” “having,” and the like, as used with respect to embodiments of the present disclosure, are synonymous.

According to the invention, the gas cylinder system includes a dual cylinder frame or cylinder holder that is very robust and that provides safe storage of one or more gas cylinders. The frame is configured to reduce and eliminate any risk toppling over. The gas cylinders are individually chained or tethered to frame of the gas cylinder holder, thereby preventing the gas cylinders from tipping over relative to the gas cylinder holder.

In one embodiment, the system includes dual stage regulators for a highly stable flow. Each cylinder lines includes a high pressure gas sensor and a low pressure gas sensor. A solenoid switch over on the low pressure side is provided. The system includes a compact manifold design, and enables high flow rates up to 400 liters/min through the entire usable cylinder pressure. The gas cylinder holder includes frame front access that enables the changing over of cylinders while they are in use, thereby providing a continuous gas flow. The electrical connections are designed to be in one harness to enable front access to the gas cylinders.

The gas cylinder system also includes a display screen, with in one embodiment, is a touch screen with controls. The electronic system includes visual and audible alerts, notifications and alarms. As described herein, the invention includes a unique vent sequence to aid cylinder change over. The electronic system also includes a Bluetooth connection for remote monitoring via a gateway hub and a battery back-up component. The system also includes a venting line that is controlled through the front electronic panel that is used to control the operation of the system and the gas cylinders. An auto-change over control with a color touch screen is provided, which utilizes alarms when users need to change a gas cylinder or if there is pressure that is too high or too low.

In one embodiment of the invention, the gas cylinder system includes an easy to use cart or trolley to move the heavy frame that supports and contains the gas cylinders. The cart or trolley is a transportation mechanism. As described below, the frame has engagement lift points that are engaged by a lifting mechanism on the cart or trolley to raise or lift the gas cylinders and the gas cylinder holder. In one embodiment, the cart utilizes a lifting mechanism that includes a pair of scissor jack systems and cams. A handle or actuator can be rotated to lift up the gas cylinder holder and gas cylinders easily. As a result, the cart along with the gas cylinder holder and one or more gas cylinders can be maneuvered around easily.

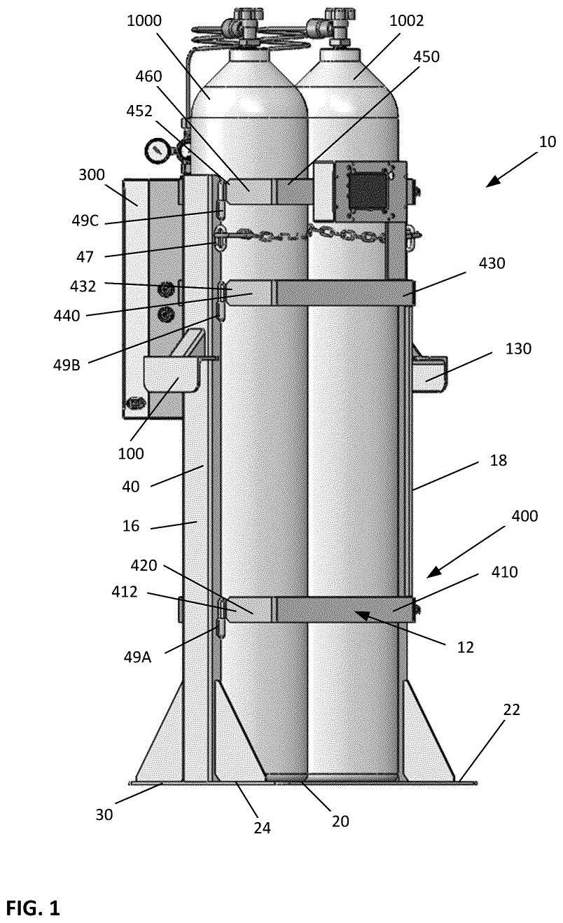

Illustrated in FIGS. 1-7 is an example embodiment of a gas cylinder holder or frame in accordance with the present invention. In this embodiment, the gas cylinder holder 10 may be configured to hold or retain two gas cylinders 1000 and 1002, including, but not limited to, two “H” cylinders. As further explained below, the gas cylinders 1000 and 1002 may be utilized while being retained within the gas cylinder holder 10, and the gas cylinder holder 10 may be configured to prevent the tipping of the gas cylinders 1000 and 1002 and/or the gas cylinder holder 10 itself. The gas cylinder holder 10 may have a front side 12, an opposite rear side 14, a first side 16 spanning between the front side 12 and the rear side 14, and a second side 18 opposite the first side 16 that also spans between the front side 12 and the rear side 14.

The gas cylinder holder 10 may include a base frame member 20, which may be substantially planar. The base frame member 20 may include a top side 22 and an opposite bottom side 24. The bottom side 24 may be configured to engage a support surface 5, while, as illustrated, the top side 22 may be configured to engage the bottom end of one or more gas cylinders. In the embodiment illustrated, the base frame member 20 may be substantially rectangular or square, and may include a front edge 26, an opposite rear edge 28, a first side edge 30 spanning from the front edge 26 to the rear edge 28, and a second side edge 32 opposite the first side edge 30 that also spans from the front edge 26 to the rear edge 28. In other embodiments, the base frame member 20 may be of any other shape. The front edge 26 of the base frame member 20 may be oriented proximate to the front side 12 of the gas cylinder holder 10, while the rear edge 28 of the base frame member 20 may be oriented proximate to the rear side 14 of the gas cylinder holder 10. The first side edge 30 of the base frame member 20 may be oriented proximate to the first side 16 of the gas cylindrical holder 10, while the second side edge 32 of the base frame member 20 may be oriented proximate to the second side 18 of the gas cylindrical holder 10.

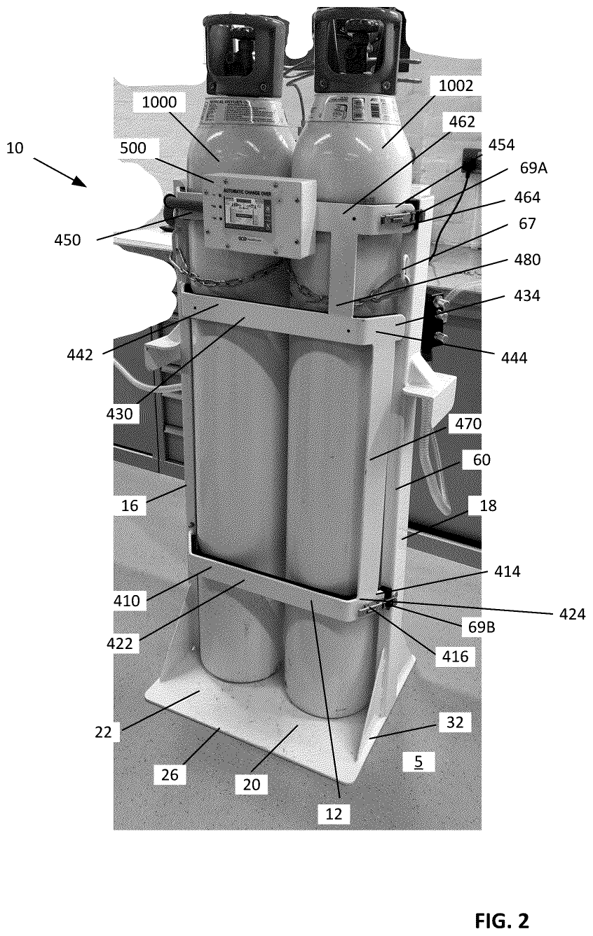

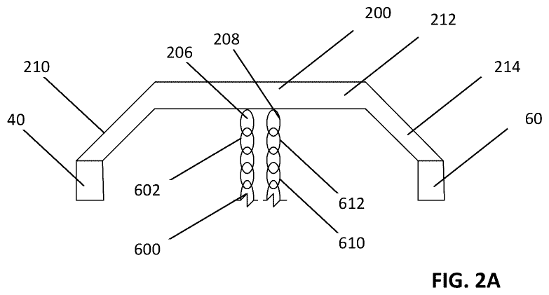

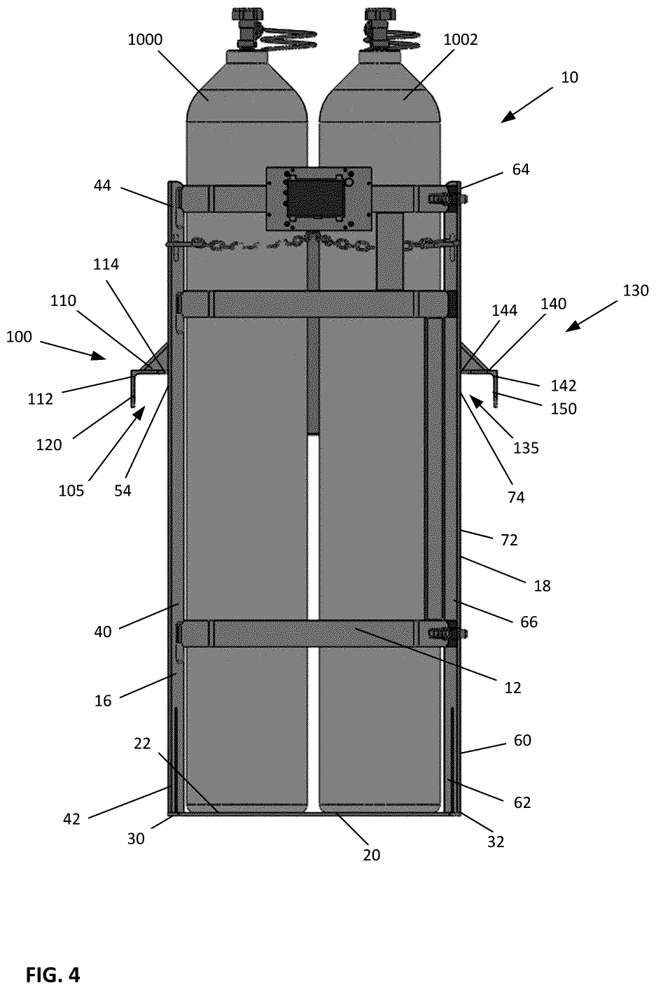

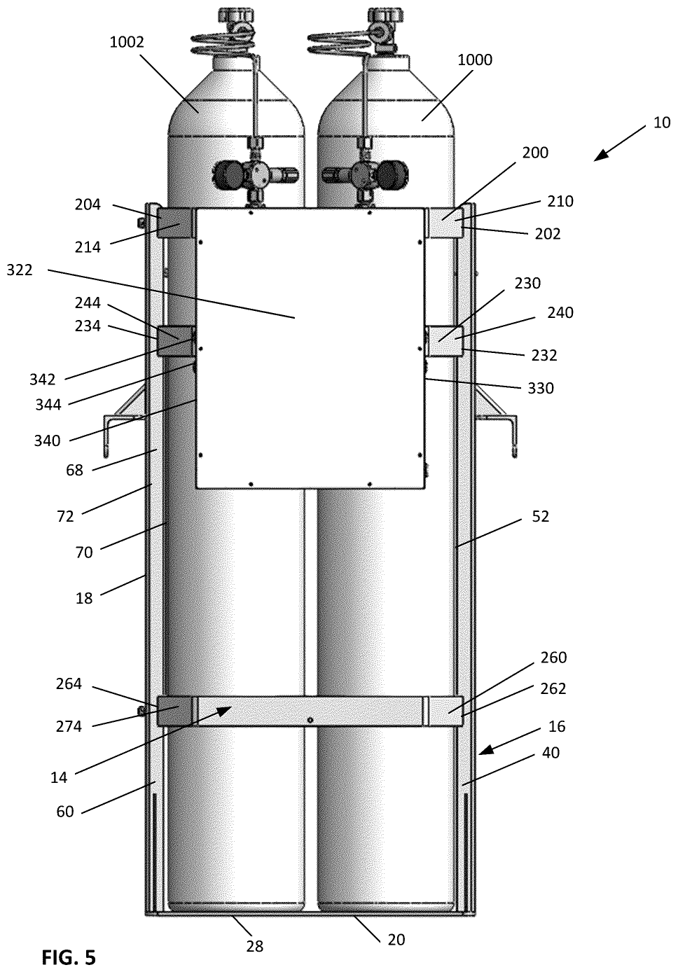

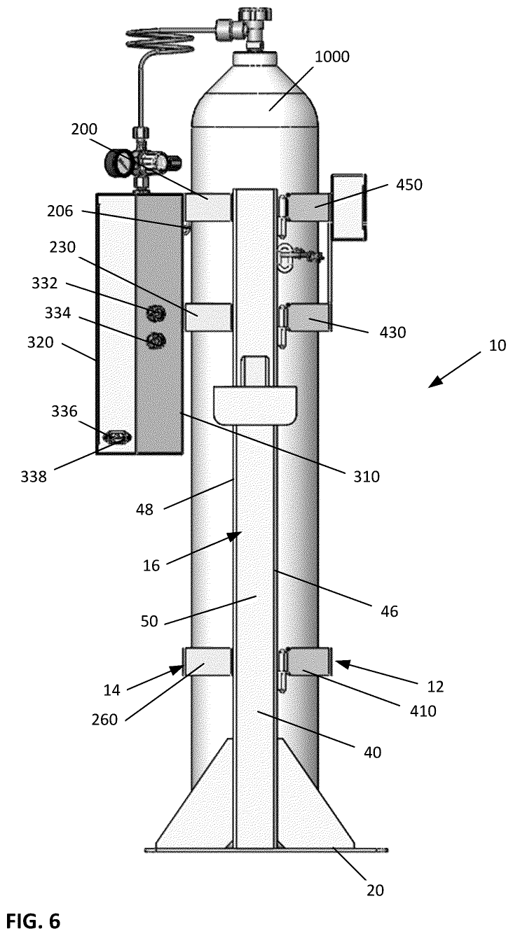

As further illustrated, the gas cylinder holder 10 may include a first upstanding frame member 40 (see FIG. 1) and a second upstanding frame member 60 (see FIG. 2). As shown in FIG. 4, each of the first upstanding frame member 40 and the second upstanding frame member 60 includes a first end 42 and 62, respectively, and an opposite second end 44 and 64, respectively. In addition, as shown in FIGS. 5 and 6, the first upstanding frame member 40 may further include a front elongated side 46, a rear elongated side 48 opposite the front elongated side 46, a first elongated side 50, and a second elongated side 52 disposed opposite the first elongated side 50. Similarly, referring to FIGS. 4 and 5, the second upstanding frame member 60 includes a front elongated side 66, a rear elongated side 68 opposite the front elongated side 66, a first elongated side 70, and a second elongated side 72 disposed opposite the first elongated side 70. In one embodiment, the first and second upstanding frame members 40 and 60 may have rectangular or square cross-sections. In other embodiments, the first and second upstanding frame members 40 and 60 may have circular cross-sections, U-shaped cross-sections, or any other shaped cross-section.

Referring to FIG. 4, the first end 42 of the first upstanding frame member 40 may be coupled to the top side 22 of the base frame member 20 proximate to the first side edge 30 of the base frame member 20, and such that the first upstanding frame member 40 is disposed equidistant from the front edge 26 and the rear edge 28. Similarly, the first end 62 of the second upstanding frame member 60 may be coupled to the top side 22 of the base frame member 20 proximate to the second side edge 32 of the base frame member 20, and such that the second upstanding frame member 60 is disposed equidistant from the front edge 26 and the rear edge 28. The front elongated sides 46 and 66 of each of the first and second upstanding frame members 40 and 60, respectively, may face generally toward the front edge 26 of the base frame member 20, while the rear elongated sides 48 and 68 of each of the first and second frame upstanding members 40 and 60, respectively, may face generally toward the rear edge 28 of the base frame member 20. Additionally, the first elongated sides 50 and 70 of each of the first and second upstanding frame members 40 and 60, respectively, may face toward the first side edge 30 of the base frame member 20, while the second elongated sides 52 and 72 of each of the first and second upstanding frame members 40 and 60, respectively, may face toward the second side edge 32 of the base frame member 20. Thus, the first upstanding frame member 40 may be disposed proximate to the first side 16 of the gas cylindrical holder 10, and the second upstanding frame member 60 may be disposed proximate to the second side 18 of the gas cylindrical holder 10.

As illustrated in FIGS. 1 and 4, disposed on the first elongated side 50 of the first upstanding frame member 40 is a first engagement member 100. The first engagement member 100 may be disposed between the first end 42 and the second end 44 of the first upstanding frame member 40. The first engagement member 100 may be coupled to the first elongated side 50 of the first upstanding frame member 40 such that the first engagement member 100 extends outwardly from the first elongated side 50 of the first upstanding frame member 40. As illustrated, the first engagement member 100 may include at least a horizontal member 110 and a vertical member 120. The horizontal member 110 may extend horizontally from the first elongated side 50 of the first upstanding frame member 40, while the vertical member 120 may descend vertically from the free end 112 (i.e., the end 112 of the horizontal member 110 that is opposite the end 114 coupled to the first elongated side 50 of the first upstanding frame member 40) of the horizontal member 110. Thus, the vertical member 120, the horizontal member 110, and a proximate portion 54 of the first elongated side 50 of the first upstanding frame member 40 collectively define a receiving region 105 of the first engagement member 110. As illustrated, the first engagement member 110 may extend outwardly from the first side 16 of the gas cylinder holder 10.

As illustrated in FIGS. 1 and 4, disposed on the second elongated side 72 of the second upstanding frame member 60 is a second engagement member 130. The second engagement member 130 may be disposed between the first end 62 and the second end 64 of the second upstanding frame member 60. The second engagement member 130 may be coupled to the second elongated side 72 of the second upstanding frame member 60 such that the second engagement member 130 extends outwardly from the second elongated side 72 of the second upstanding frame member 60. As illustrated, and similar to the first engagement member 100, the second engagement member 130 may include at least a horizontal member 140 and a vertical member 150. The horizontal member 140 may extend horizontally from the second elongated side 72 of the second upstanding frame member 60, while the vertical member 150 may descend vertically from the free end 142 (i.e., the end 142 of the horizontal member 140 that is opposite the end 144 coupled to the second elongated side 72 of the second upstanding frame member 60) of the horizontal member 140. Thus, the vertical member 150, the horizontal member 140, and a proximate portion 74 of the second elongated side 72 of the second upstanding frame member 60 collectively define a receiving region 135 of the second engagement member 130. As illustrated, the second engagement member 130 may extend outwardly from the second side 18 of the gas cylinder holder 10 in a direction that is opposite to the extending direction of the first engagement member 100. The first engagement member 100 and the second engagement member 130 may be aligned horizontally with one another (i.e., may be disposed at the same height above a support surface 5 and base frame member 20). As explained below in more detail, the first and second engagement members 100 and 130 facilitate the lifting and transportation of the gas cylinder holder 10.

As illustrated in FIGS. 1 and 6, disposed on the front elongated side 46 of the first upstanding frame member 40 is a first ring 47, where the first ring 47 is disposed more proximate to the second end 44 of the first upstanding frame member 40 than the first end 42 of the first upstanding frame member 40. Also disposed on the front elongated side 46 of the first upstanding frame member 40 are three hinges 49A, 49B, 49C. The first hinge 49A may be disposed on the front elongated side 46 of the first upstanding frame member 40 more proximate to the first end 42 of the first upstanding frame member 40 than the second end 44 of the first upstanding frame member 40. The third hinge 49C may be disposed on the front elongated side 46 of the first upstanding frame member 40 more proximate to the second end 44 of the first upstanding frame member 40 than the first end 42 of the first upstanding frame member 40. Furthermore, the second hinge 49B may be disposed on the front elongated side 46 of the first upstanding frame member 40 between the first hinge 49A and the third hinge 49C. More specifically, the second hinge 49B may be disposed on the front elongated side 46 of the first upstanding frame member 40 more proximate to the third hinge 49C than the first hinge 49A.

Referring to FIGS. 2 and 4, disposed on the front elongated side 66 of the second upstanding frame member 60 is a second ring 67, where the second ring 67 is disposed more proximate to the second end 64 of the second upstanding frame member 60 than the first end 62 of the second upstanding frame member 60. Also disposed on the front elongated side 66 of the second upstanding frame member 60 is a first latch/lock engagement member 69A and a second latch/lock engagement member 69B. The first latch engagement member 69A may be disposed on the front elongated side 66 of the second upstanding frame member 60 more proximate to the first end 62 of the second upstanding frame member 60 than the second end 64 of the second upstanding frame member 60. The second latch engagement member 69B may be disposed on the front elongated side 66 of the second upstanding frame member 60 more proximate to the second end 64 of the second upstanding frame member 60 than the first end 62 of the second upstanding frame member 60. The first latch engagement member 69A may be horizontally aligned with the first hinge 49A disposed on the front elongated side 50 of the first upstanding frame member 40. The second latch engagement member 69B may be horizontally aligned with the third hinge 49C disposed on the front elongated side 46 of the first upstanding frame member 40. While not shown, other embodiments of the gas cylinder holder 10 may include a third latch/lock engagement member that is disposed on the front elongated side 66 of the second upstanding frame member 60 more proximate to the second latch engagement member 69B than the first latch engagement member 69A, and such that the third latch engagement member is horizontally aligned with the second hinge 49B.

Referring to FIGS. 2A, 3, 5, 6, and 7, the gas cylinder holder 10 further includes several rear horizontal members disposed on the rear side 14 of the gas cylinder holder 10. In the illustrated embodiment, the rear side 14 of the gas cylinder holder 10 includes three rear horizontal members. In other embodiments, however, the rear side 14 of the gas cylinder holder 10 may include any number of rear horizontal members, any number of rear vertical members, and/or any number of panels.

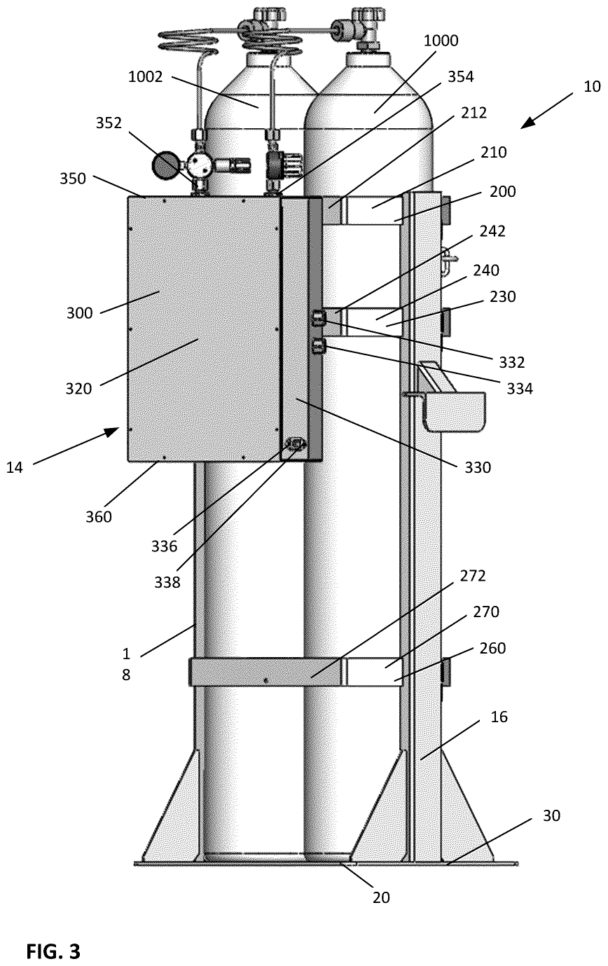

As illustrated, each of the rear horizontal members has the same general structure. In one embodiment, referring to FIGS. 3 and 5, rear horizontal member 200 includes a first end 202 and an opposite second end 204. Furthermore, rear horizontal member 200 includes a first end portion 210 disposed proximate to the first end 202 of the horizontal member 200, a second end portion 214 disposed proximate to the second end 204 of the horizontal member 200, and an intermediate portion 212 disposed between the first end portion 210 and second end portion 214. Each of the first end portion 210 and the second end portion 214 may be angled (i.e., not parallel) with respect to the intermediate portion 212, while also not being parallel with each other. The first end portion 210 and the second end portion 214 may also be smaller in length than the intermediate portion 212 of rear horizontal member 200.

Similarly, rear horizontal member 230 includes a first end 232 and an opposite second end 234. Furthermore, rear horizontal member 230 includes a first end portion 240 disposed proximate to the first end 232 of rear horizontal member 230, a second end portion 244 disposed proximate to the second end 234 of rear horizontal member 230, and an intermediate portion 242 disposed between the first end portion 240 and the second end portion 244. Each of the first end portion 240 and the second end portion 244 may be angled (i.e., not parallel) with respect to the intermediate portion 242, while not being parallel with each other. The first end portion 240 and the second end portion 244 may also be smaller in length than the intermediate portion 242 of rear horizontal member 230.

Also, rear horizontal member 260 includes a first end 262 and an opposite second end 264. Furthermore, rear horizontal member 260 may include a first end portion 270 disposed proximate to the first end 262 of rear horizontal member 260, a second end portion 274 disposed proximate to the second end 262 of rear horizontal member 260, and an intermediate portion 272 disposed between the first end portion 270 and the second end portion 274. Each of the first end portion 270 and the second end portion 274 may be angled (i.e., not parallel) with respect to the intermediate portion 272, while also not being parallel with each other. The first end portion 270 and the second end portion 274 may also be smaller in length than the intermediate portion 272 of rear horizontal member 260.

Now the mounting of the rear horizontal members 200, 230, and 260 is described. Rear horizontal members 200, 230, and 260 can be referred to alternatively as the upper or top rear horizontal member 200, the middle or intermediate rear horizontal member 230, and the lower or bottom rear horizontal member 260. The first end 202 of rear horizontal member 200 (and the associated first end portion 210) may be coupled to the rear elongated side 48 of the first upstanding frame member 40, while the second end 204 of rear horizontal member 200 (and the associated second end portion 214) may be coupled to the rear elongated side 68 of the second upstanding frame member 60. The ends 202 and 204 of rear horizontal member 200 may be fixedly attached to the rear elongated sides 48 and 68 of the first upstanding frame member 40 and second upstanding frame member 60, respectively.

Similarly, the first end 232 of rear horizontal member 230 (and the associated first end portion 240) may be coupled to the rear elongated side 48 of the first upstanding frame member 40, while the second end 234 of rear horizontal member 230 (and the associated second end portion 244) may be coupled to the rear elongated side 68 of the second upstanding frame member 60. The ends 232 and 234 of rear horizontal member 230 may be fixedly attached to the rear elongated sides 48 and 68 of the first upstanding frame member 40 and second upstanding frame member 60, respectively.

Also, the first end 262 of rear horizontal member 260 (and the associated first end portion 270) may be coupled to the rear elongated side 48 of the first upstanding frame member 40, while the second end 264 of rear horizontal member 260 (and the associated second end portion 274) may be coupled to the rear elongated side 68 of the second upstanding frame member 60. The ends 262 and 264 of rear horizontal member 260 may be fixedly attached to the rear elongated sides 48 and 68 of the first upstanding frame member 40 and second upstanding frame member 60, respectively.

Now the particular alignment of the rear horizontal members is described. As shown, starting with lower rear horizontal member 260, the first end 262 of lower rear horizontal member 260 (and the associated first end portion 270) may be aligned horizontally with the first hinge 49A disposed on the front elongated side 46 of the first upstanding frame member 40, while the opposite second end 264 of lower rear horizontal member 260 (and the associated second end portion 274) may be aligned horizontally with the first latch engagement member 69B disposed on the front elongated side 66 of the second upstanding frame member 60. Thus, lower rear horizontal member 260 spans horizontally across the rear side 14 of the gas cylinder holder 10 from the first side 16 to the second side 18 (and from the first upstanding frame member 40 to the second upstanding frame member 60).

Turning to upper rear horizontal member 200, the first end 202 of upper rear horizontal member 200 (and the associated first end portion 210) may be aligned horizontally with the third hinge 49C disposed on the front elongated side 46 of the first upstanding frame member 40, while the opposite second end 204 of upper rear horizontal member 200 (and the associated second end portion 214) may be aligned horizontally with the second latch engagement member 69B disposed on the front elongated side 66 of the second upstanding frame member 60. Thus, upper rear horizontal member 200 spans horizontally across the rear side 14 of the gas cylinder holder 10 from the first side 16 to the second side 18 (and from the first upstanding frame member 40 to the second upstanding frame member 60). Intermediate rear horizontal member 230 may be disposed between upper rear horizontal member 200 and lower rear horizontal member 260 so that intermediate rear horizontal member 230 is located closer to upper rear horizontal member 200 than lower rear horizontal member 260.

As illustrated in FIGS. 1, 3, 5 and 6, an outlet cabinet 300 may be disposed on the rear side 14 of the gas cylinder holder 10. The outlet cabinet can be referred to alternatively as an electronic cabinet or an electronic component. The outlet cabinet 300 may be coupled to both the upper rear horizontal member 200 and the intermediate rear horizontal member 230. The outlet cabinet 300 may be spaced along the upper rear horizontal member 200 and the intermediate rear horizontal member 230 such that the outlet cabinet 300 is spaced equidistant from the first upstanding frame member 40 and the second upstanding frame member 60. As explained in further detail below, the outlet cabinet 300 may be configured to be connected to both gas cylinders 1000 and 1002 installed in the gas cylinder holder 10, and configured to dispense gas from the installed gas cylinders 1000 and 1002 as desired by an operator.

In one embodiment, the outlet cabinet 300 may include a front side 310, which is coupled to the upper rear horizontal member 200 and the intermediate rear horizontal member 230, and an opposite rear side 320, which may contain a cabinet door 322 that provides access to the interior volume of the outlet cabinet 300. The outlet cabinet 300 may include a first side 330, and opposite second side 340, a top side 350, and a bottom side 360, all of which collectively define the interior volume of the outlet cabinet 300. As illustrated, extending through the top side 350 of the cabinet 300 are two connection lines or inlet lines 352 and 354 (see FIG. 3) that are configured to fluidly connect with the cylinders 1000 and 1002 disposed in the gas cylinder holder 10 and configured to provide gas from the cylinders 1000 and 1002 to the outlet cabinet 300. Disposed on the first side 330 of the outlet cabinet 300 may be two gas ports 332 and 334, and two electrical ports 336 and 338. Disposed on the second side 340 of the outlet cabinet 300 may be two additional gas ports 342 and 344. While the illustrated embodiment of the outlet cabinet 300 includes four outlet gas ports, other embodiments of the outlet cabinet 300 may include any number of outlet gas ports that may be disposed on any side of the outlet cabinet 300. In addition, other embodiments of the outlet cabinet 300 may have any number of electrical ports that may be disposed on any of the sides of the outlet cabinet 300.

As best illustrated in FIGS. 1, 2, 4, 6, and 7, the gas cylinder holder 10 includes a door 400 that is disposed on the front side 12 of the gas cylinder holder 10. The embodiment of the door 400 illustrated contains at least three front horizontal members (e.g., a lower front horizontal member 410, an intermediate front horizontal member 430, and an upper front horizontal member 450 (see FIGS. 1 and 2)) and two front vertical members (e.g., a first front vertical member 470 and a second front vertical member 480 (see FIG. 2)).

As illustrated in FIGS. 1 and 2, the lower front horizontal member 410 of the door 400 includes a first end 412 and an opposite second end 414. Furthermore, the lower front horizontal member 410 of the door 400 may include a first end portion 420 disposed proximate to the first end 412 of the lower front horizontal member 410, a second end portion 424 disposed proximate to the second end 414 of the lower front horizontal member 410, and an intermediate portion 422 disposed between the first end portion 420 and the second end portion 424. The first end portion 420 and the second end portion 424 may be angled (i.e., not parallel) with respect to the intermediate portion 422, while also not being parallel with each other. Each of the first end portion 420 and the second end portion 424 may also be smaller in length than the intermediate portion 422 of lower front horizontal member 410.

Similarly, the intermediate front horizontal member 430 of the door 400 includes a first end 432 and an opposite second end 434. Furthermore, the intermediate front horizontal member 430 may include a first end portion 440 disposed proximate to the first end 432 of the intermediate front horizontal member 430, a second end portion 444 disposed proximate to the second end 434 of the intermediate front horizontal member 430, and an intermediate portion 442 disposed between the first end portion 440 and the second end portion 444. The first end portion 440 and the second end portion 444 may be angled (i.e., not parallel) with respect to the intermediate portion 442, while also not being parallel with each other. Each of the first end portion 440 and the second end portion 444 may also be smaller in length than the intermediate portion 442 of the intermediate front horizontal member 430.

Also, the upper front horizontal member 450 of the door 400 includes a first end 452 and an opposite second end 454. Furthermore, the upper front horizontal member 450 of the door 400 may include a first end portion 460 disposed proximate to the first end 452 of the upper front horizontal member 450, a second end portion 464 disposed proximate to the second end 454 of the upper front horizontal member 450, and an intermediate portion 462 disposed between the first end portion 460 and the second end portion 464. The first end portion 460 and the second end portion 464 may be angled (i.e., not parallel) with respect to the intermediate portion 462, while also not being parallel with each other. Each of the first end portion 460 and the second end portion 464 may also be smaller in length than the intermediate portion 462 of the upper front horizontal member 450.

As further illustrated in FIG. 2, the first front vertical member 470 spans from the second end portion 424 of the lower front horizontal member 410 to the second end portion 444 of the intermediate front horizontal member 430, while the second front vertical member 480 spans from the intermediate portion 442 of the intermediate front horizontal member 430 (proximate to the second end portion 444 thereof) to the intermediate portion 462 of the upper front horizontal member 450 (proximate to the second end portion 464 thereof).

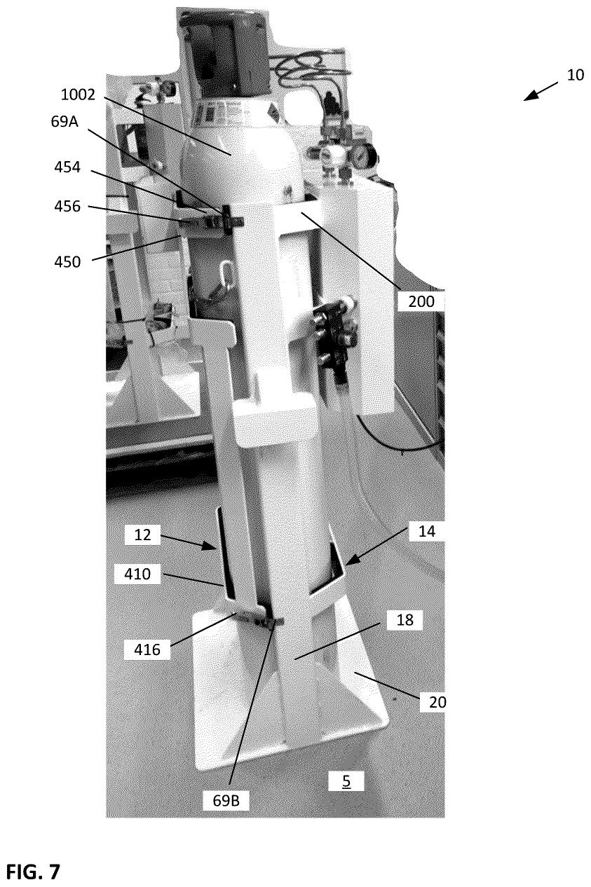

The first end 412 of the lower front horizontal member 410 (and the associated first end portion 420) may be coupled to the first hinge 49A disposed on the first upstanding frame member 40 (see FIG. 1). The opposite second end 414 of the lower front horizontal member 410 (and the associated second end portion 424 thereof) may include a latch mechanism 416 that is capable of and configured to engage with the first latch engagement member 69B when the door 400 is in its closed position (see FIGS. 2 and 7). Thus, the lower front horizontal member 410 spans horizontally across the front side 12 of the gas cylinder holder 10 from the first side 16 to the second side 18 (and from the first upstanding frame member 40 to the second upstanding frame member 60) when the door 400 is in its closed position. In addition, the lower front horizontal member 410 may be horizontally aligned with the lower rear horizontal member 260 (as best illustrated in FIGS. 6 and 7).

Returning to FIG. 1, the first end 432 of the intermediate front horizontal member 430 (and the associated first end portion 440) may be coupled to the second hinge 49B disposed on the first upstanding frame member 40. Unlike the lower front horizontal frame member 410, the opposite second end 434 of the intermediate front horizontal member 430 (and the associated second end portion 444) may not include a latch mechanism. However, the intermediate front horizontal member 430 may still span horizontally across the front side 12 of the gas cylinder holder 10 from the first side 16 to the second side 18 (and from the first upstanding frame member 40 to the second upstanding frame member 60) when the door 400 is in its closed position. The intermediate front horizontal member 430 may be horizontally aligned with the intermediate rear horizontal member 230 (as best illustrated in FIGS. 6 and 7).

In FIG. 1, the first end 452 of the upper front horizontal member 450 (and the associated first end portion 460) may be coupled to the third hinge 49C disposed on the first upstanding frame member 40. Referring to FIGS. 2 and 7, the opposite second end 454 of the upper front horizontal member 450 (and the associated second end portion 464) may also include a latch mechanism 456 that is capable of and configured to engage with the second latch engagement member 69A when the door 400 is in its closed position. Thus, the upper front horizontal member 450 spans horizontally across the front side 12 of the gas cylinder holder 10 from the first side 16 to the second side 18 (and from the first upstanding frame member 40 to the second upstanding frame member 60) when the door 400 is in its closed position. The upper front horizontal member 450 may be horizontally aligned with the upper rear horizontal member 260 (as best illustrated in FIGS. 6 and 7).

The door 400 is configured to rotate between an opened position and a closed position about an axis extending vertically through the hinges 49A, 49B, and 49C disposed on the first upstanding frame member 40. Because the front horizontal members 410, 430, and 450 are interconnected with one another via the front vertical members 470 and 480, the front horizontal members 410, 430, and 450 and the front vertical members 470 and 480 collectively form door 400 and move in unison between the opened position and the closed position. As previously explained, when in the closed position, as illustrated, the second ends 414, 434, and 454 of the front horizontal members 410, 430, and 450, respectively, may be disposed proximate to the second upstanding frame member 60, and the latch mechanisms 416 and 456 of the lower and upper front horizontal members 410 and 450, respectively, may be configured to engage with the latch engagement members 69B and 69A, respectively, of the second upstanding frame member 60 to secure or lock the door 400 in the closed position.

When the door 400 is in the closed position, the base frame member 20, the door 400, the first upstanding frame member 40, the second upstanding frame member 60, and the rear horizontal members 200, 230, and 260 collectively define a storage region configured to receive and retain the gas cylinders 1000 and 1002 disposed within the gas cylinder holder 10. In the other embodiments, the size of the storage region defined by the base frame member 20, the door 400, the first upstanding frame member 40, the second upstanding frame member 60, and the rear horizontal members 200, 230, and 260 can vary and be configured to receive and retain any number of gas cylinders. As explained in further detail below, when the door 400 is in the opened position, gas cylinders 1000 and 1002 may be removed from, or placed into, the storage region of the gas cylinder holder 10. In other embodiments, the door 400 have any shape or size that allows it to perform similarly to that of the door 400 illustrated and described herein.

As further illustrated in FIG. 2, a control panel 500 may be disposed on the door 400 of the gas cylinder holder 10. In the illustrated embodiment, the control panel 500 may be disposed on the upper front horizontal member 450 of the door 400. However, in other embodiments, the control panel 500 may be disposed on any other front horizontal or vertical member of the door 400 and/or may be disposed between the front horizontal and/or vertical members of the door 400. In even further embodiments, the control panel 500 may be disposed on other portions of the gas cylinder holder 10. As explained in further detail below, the control panel 500 may be electrically connected to the outlet cabinet 300 (and one or more of the components disposed in the outlet cabinet 300), and may be configured to provide the status of the gas cylinders 1000 and 1002 and the flow of gas, as well as control the flow of gas via the components of the outlet cabinet 300.

As previously explained and shown in FIGS. 1 and 2, disposed on the front elongated sides 46 and 66 of the first and second upstanding frame members 40 and 60 are rings 47 and 67. The first ring 47 may be disposed on the front elongated side 46 of the first upstanding frame member 40 between the first end 432 of the intermediate front horizontal member 430 and the first end 452 of the upper front horizontal member 450. Thus, the first ring 47 may be disposed between the second hinge 49B and the third hinge 49C. The second ring 67, which is disposed on the front elongated side 66 of the second upstanding frame member 60, may be horizontally aligned with the first ring 47. Thus, when the door 400 is in the closed position, the second ring 67 may be disposed between the second end 434 of the intermediate front horizontal member 430 and the second end 454 of the upper front horizontal member 450.

As best illustrated in FIGS. 1, 2, 2A, 4, 6, 7, and 9, a first tether 600 and a second tether 610 may be utilized to further secure the gas cylinders 1000 and 1002 within the storage region of the gas cylinder holder 10. The first tether 600 has a first end 602 with a receiving portion that is coupled to a coupler 206 disposed on the upper rear horizontal member 200 (see FIG. 2A). Similarly, the second tether 610 includes a first end 612 that is coupled to a coupler 208 disposed on the upper rear horizontal member 200. In different embodiments, either one or both of the first ends 602 and 612 of the tethers 600 and 610 can be coupled to the intermediate rear horizontal member 230 instead of the upper rear horizontal member 200.

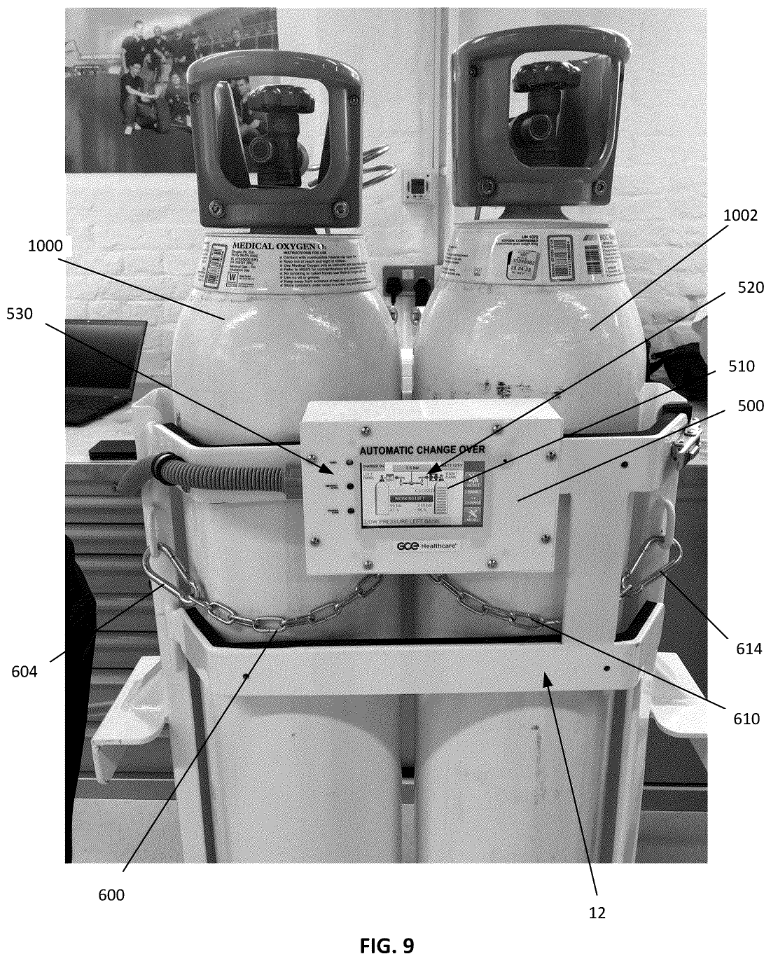

Referring to FIG. 9, the first tether 600 includes a second end 604 that may be removably coupled to the first ring 47. Similarly, the second tether 610 includes a second end 614 that may be removably coupled to the second ring 67. As illustrated, the first tether 600 may provide additional securement of a first gas cylinder 1000 within the storage region such that the first gas cylinder 1000 is secured against the first upstanding frame member 40 and the rear horizontal members 200, 230, and 260. The second tether 610 may provide additional securement of a second gas cylinder 1002 within the storage region such that the second gas cylinder 1002 is secured against the second upstanding frame member 60 and the rear horizontal members 410, 430, and 450. Thus, when the door 400 is in the opened position, the first tether 600 and the second tether 610 provide an additional securing mechanism for securing the gas cylinders 1000 and 1002 in the storage region. In the illustrated embodiment, the tethers 600 and 610 may be chains, while in other embodiments the tethers may be constructed or formed from any other material suitable for secure large gas cylinders and preventing large gas cylinders from tipping over.

When the gas cylinder holder 10 does not contain any gas cylinders in the storage region, an operator may unlatch the latch mechanisms 416 and 456 of the door 400 from the latch engagement members 69A and 69B, and then rotate the door 400 about the vertical axis extending through the hinges 49A, 49B, and 49C from the closed position (i.e., the second ends 414, 434, and 454 of the front horizontal members 410, 430, and 450 being disposed adjacent to the second upstanding frame member 60) to the open position (i.e., the second ends 414, 434, and 454 of the front horizontal members 410, 430, and 450 being spaced from the second upstanding frame member 60). With the door 400 in the opened position, the operator may position a first gas cylinder 1000 in the storage region such that the first gas cylinder 1000 is disposed on the base frame member 20 proximate to the first upstanding frame member 40. The operator may then position the first tether 600 around the first gas cylinder 1000 and attach the second end 604 of the first tether 600 to the first ring 47 of the first upstanding frame member 40. With the first gas cylinder 1000 located in the storage region, the operator may then position the second gas cylinder 1002 in the storage region such that the second gas cylinder 1002 is disposed on the base frame member 20 proximate to the second upstanding frame member 60. The operator may then position the second tether 610 around the second gas cylinder 1002 and attach the second end 614 of the second tether 610 to the second ring 67 of the second upstanding frame member 60. With both gas cylinders 1000 and 1002 disposed in the storage region, the operator may then rotate the door 400 about the vertical axis extending through the hinges 49A, 49B, and 49C from the opened position to the closed position. With the door 400 in the closed position, the operator may then latch the first latch mechanism 416 to the first latch engagement member 69B and the second latch mechanism 456 to the second latch engagement member 69A (see FIG. 7). With the gas cylinders 1000 and 1002 secured in the storage region of the gas cylinder holder 10, the operator may then couple the inlet lines 352 and 354 of the outlet cabinet 300 to the gas cylinders 1000 and 1002, respectively.

As previously explained, the outlet cabinet 300 includes two inlet lines 352 and 354 extending outwardly from the top side 350 of the outlet cabinet 300, where each inlet line is coupled to a respective gas cylinder. The inlet lines 352 and 354 may be equipped with cylinder fittings that are capable of being hand tightened onto the outlet of the gas cylinders 1000 and 1002.

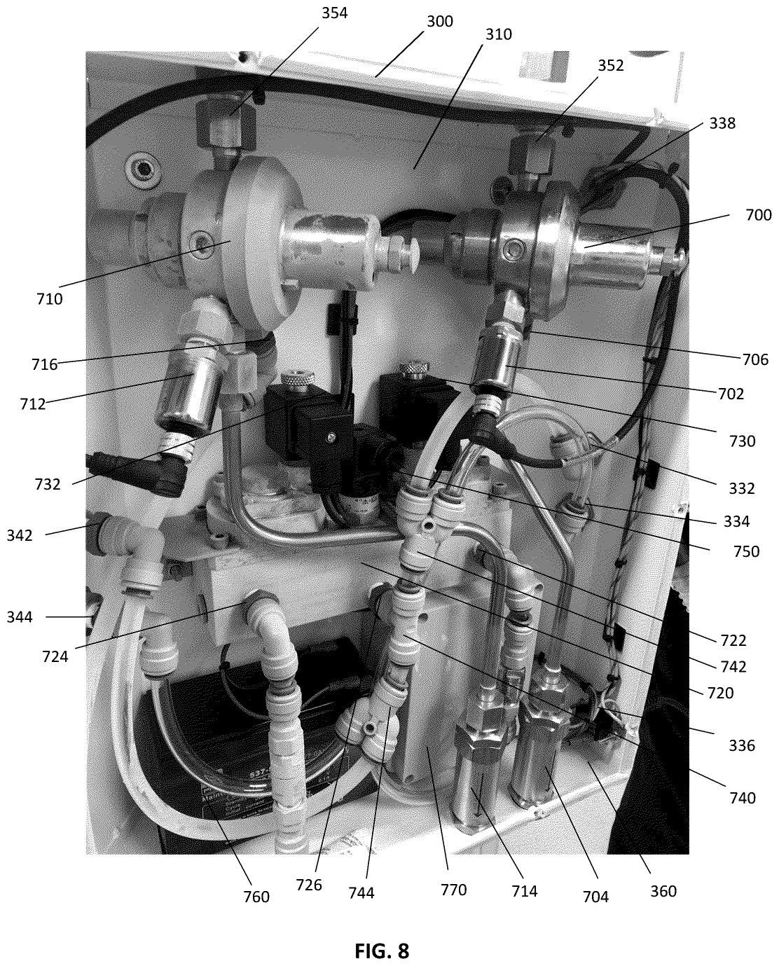

As best illustrated in FIG. 8, the outlet cabinet 300 may include a series of components disposed within the outlet cabinet 300 that facilitate the outflow of gas from the cylinders 1000 and 1002 disposed within the storage region of the gas cylinder holder 10. Each of the inlet lines 352 and 354 may be fluidly coupled to a dual stage regulator 700 and 710, respectively, disposed within the outlet cabinet 300. Each dual stage regulator 700 and 710 may be configured to promote a highly stable flow of gas from a respective gas cylinder. As further illustrated, fluidically coupled to regulator 700 is a gas pressure sensor 702, a venting line 704, and a pressure outlet 706. Similarly, fluidically coupled to regulator 710 is a gas pressure sensor 712, a venting line 714, and a pressure outlet 716. The gas pressure sensors 702 and 712 may be electrically and operatively coupled to the control panel 500 such that the control panel 500 may be capable of reading the pressure of the gas in the supply lines 352 and 354 and flowing through the regulators 700 and 710. The venting lines 704 and 714, as illustrated, extend from the regulators 700 and 710 to the bottom wall or bottom side 360 of the outlet cabinet 300.

Each of the dual stage regulators 700 and 710 may be coupled to a manifold 720 such that the gas flowing from each dual stage regulator 700 and 710 flows into a respective inlet 722 or 724, respectively, of the manifold 720. The manifold 720 may be equipped with two solenoid valves 730 and 732 (one for each respective cylinder) that facilitate the transition of gas flowing out of the outlet cabinet 300 from one gas cylinder to another gas cylinder (i.e., by switching between the flows from each of the dual stage regulators 700 and 710). Thus, one solenoid valve 730 is disposed proximate the pressure outlet or outlet line 706 from the regulator 700 of the first cylinder 1000, while a second solenoid valve 732 is disposed proximate to the outlet line or pressure outlet 716 from the regulator 710 of the second cylinder 1002. The solenoid valves 730 and 732 may at least partially dictate from which cylinder the gas flows. The solenoid valves 730 and 732 may be electrically coupled to the control panel 500 such that the control panel 500 may control the operations (i.e., whether the valves are open or closed, to what extent the valves are open, etc.) of the solenoid valves 730 and 732. As further illustrated in FIG. 8, the manifold 720 may include a single outlet 726 disposed between the two inlets 722 and 724. Coupled to the outlet 726 is a gas line 740 that contains multiple branches 742 and 744 that fluidly couple the outlet 726 of the manifold 720 to each of the outlets or gas ports 342 and 344 on second side wall 340 and to each of the outlets or gas ports 332 and 334 of first side or side wall 330 of the outlet cabinet 300. The manifold 720 may further include a low pressure sensor/transmitter 750 that may be electrically coupled to the control panel 500. The low pressure sensor 750 may be configured to indicate to the control panel 500 the pressure of the flow of gas proximate to the outlet 726 of the manifold 720.

Various components of the outlet cabinet 300 (e.g., the solenoid valves, the pressure sensors, etc.) may be powered by a battery 760 located within the outlet cabinet 300. As further illustrated in FIG. 8, the outlet cabinet 300 may also contain a charging control circuit or step down circuit 770 that is configured to receive external power to charge the battery 760 disposed within the outlet cabinet 300. In other embodiments, the components may be powered by an electrical power line that enters into the interior volume of the outlet cabinet 300 via one of the sides of the cabinet 300. The control panel 500 disposed on the door 400 of the gas cylinder holder 10 may also be powered by the battery 760 disposed within the outlet cabinet 300 or by an external electrical power line.

As best illustrated in FIG. 9, the control panel 500 may be equipped with a display 510 and controls 520 (i.e., touch screen controls, buttons, switches, dials, etc.) for controlling operations of the outlet cabinet 300 and the gas cylinder holder 10. In the illustrated embodiment, the display 510 may be a touch screen display that contains the various controls for the control panel 500 (i.e., the operator may control the control panel 500 via the touch screen display 510). The illustrated control panel 500 may be configured to display, among other features, the amount of gas left within each cylinder 1000 and 1002 disposed within the gas cylinder holder 10, the pressure of each gas cylinder 1000 and 1002 disposed within the gas cylinder holder 10, the pressure at the output of the manifold 720, and an indication of the gas cylinder that is currently supplying gas. The control panel 500 may be further configured to display whether or not the battery 760 disposed within the outlet cabinet 300 is being charged or drained, as well as the amount of charge left in the battery 760.

In addition to the display, the control panel 500 may be further equipped with visual and audible alerts/alarms. As further illustrated in FIG. 9, the control panel 500 may include a series of indicator lights 530 that may indicate at least the control panel's power status (i.e., whether or not the control panel is on), if an emergency alarm has been triggered (i.e., if an emergency/dangerous condition has arisen), and if there are any operating alarms that have been triggered (i.e., if an improper operation has arisen). The indicator lights 530 may be a series of light emitting diodes (LED's) disposed adjacent to the display 510, where each LED may represent a separate alert/alarm/status of the control panel 500 and system. The LEDs may be of various colors. In other embodiments, the control panel 500 may not contain any indicator lights, and any visual alert/alarm/status of the control panel system may be displayed via the display 510. While not illustrated, the control panel 500 may include an audible output device (e.g., speaker, etc.) therein that can produce an output that is audible by an operator. The audible output device may be configured to produce different sounding audible outputs depending on the alert/alarm/status of the control panel and system. Furthermore, the audible output device may produce the audible outputs either simultaneously, before, or after a corresponding LED is illuminated.

In addition, the control panel 500 may be equipped with a network device (e.g., network card, wireless network adapter, etc.) that facilitates the control panel 500 to connect wirelessly (i.e., Wi-Fi, Bluetooth, Bluetooth LE, ZigBee, Z-Wave, etc.) to external devices. The control panel's ability to connect wirelessly to an external device enables an operator to remotely monitor the output of gas of the gas cylinders from a remote location.

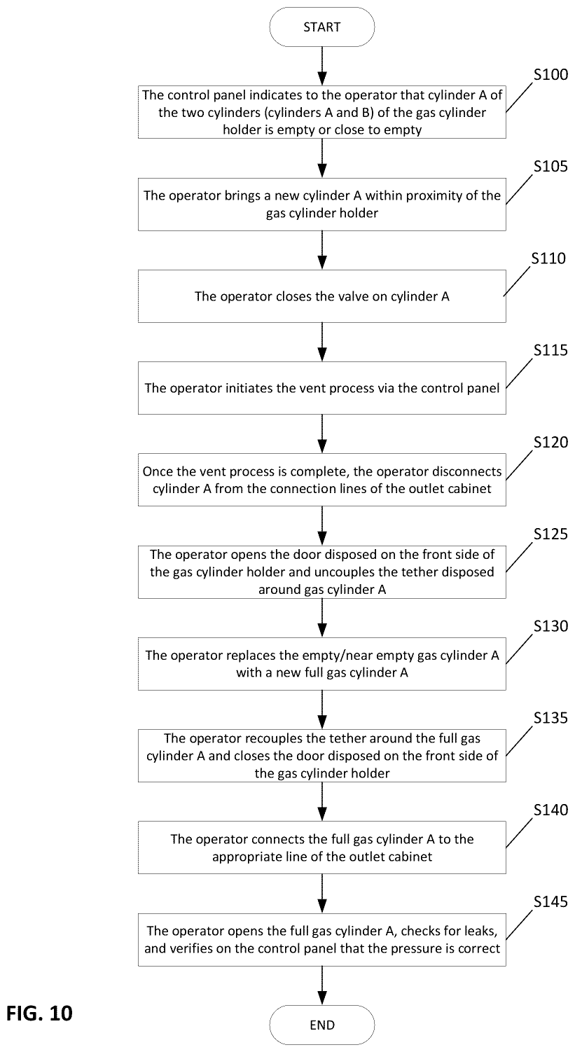

Turning to FIG. 10, and with continued reference to FIGS. 1-9, illustrated is an exemplary flowchart of the steps for changing out a gas cylinder from the gas cylinder holder. As previously explained, the gas cylinder holder 10, and more specifically, the control panel 500, continuously monitors the amount of gas within each gas cylinder 1000 and 1002 disposed within the storage region the gas cylinder holder 10. At S100, the control panel 500 may indicate to the operator that one of the cylinders (e.g., the first cylinder, cylinder A, etc.) of the two cylinders (e.g., cylinders one and two, cylinders A and B, etc.) disposed within the storage area of the gas cylinder holder 10 is empty or close to empty. The control panel 500 may alert the operator by illuminating one of the LED's 530 of the control panel 500, by displaying a prompt on the display screen or display 510, and/or by producing an audible output. Once the control panel 500 detects that the gas cylinder A is empty or close to empty, the control panel 500 may shut the valve 730 (e.g., first solenoid valve 730) of the supply lines from the gas cylinder A, and open the valve 732 (e.g., second solenoid valve 732) of the supply lines from the gas cylinder B to cease supplying gas from the gas cylinder A and to begin supplying gas from the gas cylinder B.

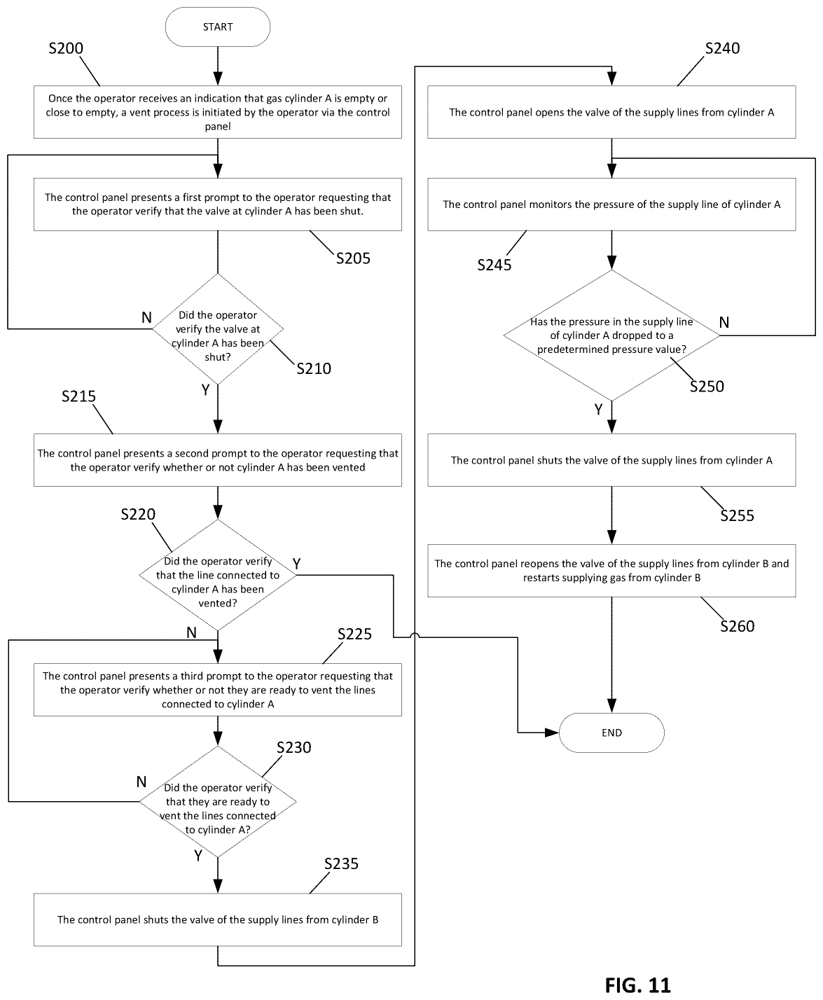

In response to being alerted by the control panel 500, at S105, the operator may then bring a new full cylinder in proximity to the gas cylinder holder 10. The operator may then, at S110, close the valve 730 on the empty gas cylinder A disposed within the storage area of the gas cylinder holder 10 by hand tightening the valve at the top of the empty gas cylinder A. Once the empty gas cylinder A has been closed, at S115, the operator initiates the vent process via the control panel 500. The vent process, as shown in FIG. 11 and described in more detail below, vents the remaining amount of gas out of the connection lines to the outlet cabinet, making it safe for the operator to disconnect the empty gas cylinder A from the outlet cabinet. At S120, once the vent process has been completed, the operator disconnects the empty gas cylinder A from the connection lines of the outlet cabinet. Thus, the operator disconnects the connection lines of the outlet cabinet from the valve at the top of the empty gas cylinder A.

At S125, the operator may then open the door 400 disposed on the front side 12 of the gas cylinder holder 10. This may be accomplished by unlatching the latch mechanisms 416 and 456 of the door 400 from the latch engagement members 69A and 69B of the second upstanding frame member 60 and then swinging the door 400 from the closed position to the open position about the vertical axis extending through the hinges 49A, 49B, and 49C of the first upstanding frame member 40. At S125, the operator may disconnect the tether disposed around the empty gas cylinder A by uncoupling the second end of the tether from one of the rings 47 or 67 of the upstanding frame members 40 or 60. At S130, the operator may then swap the empty gas cylinder A with the new full gas cylinder A. With the door 400 open and the tether uncoupled, the operator may be free to pull the empty gas cylinder A out from the storage region of the gas cylinder holder 10. With the empty gas cylinder A removed from the storage region of the gas cylinder holder 10, the operator may place the new empty gas cylinder A into the storage region of the gas cylinder holder 10. At S135, the operator may wrap the tether around the new full gas cylinder A and may couple the second end of the tether to one of the rings 47 or 67 of the upstanding frame members 40 or 60 to initially secure the new full gas cylinder A within the storage region of the gas cylinder holder 10. The operator may also, at S135, close the door 400 and reengage the latch mechanisms 416 and 456 of the door 400 with the latch engagement members 69A and 69B of the second upstanding frame member 60. This completely secures the new full gas cylinder A within the storage region of the gas cylinder holder 10.

With the new full gas cylinder A secured within the storage region of the gas cylinder holder 10, the operator, at S140, may connect the new full gas cylinder A to the associated connection lines of the outlet cabinet 300. The connection lines may connect to the valve disposed on the top of the full gas cylinder A. At S145, the operator may then open the new full gas cylinder A by hand turning the valve of the new full gas cylinder A to the open position. The operator may then check to make sure that there are no leaks at the connection of the valve of the new full gas cylinder A to the connection lines of the outlet cabinet, and may verify, on the control panel 500, that the gas pressure detected by the sensors of the outlet cabinet 300 is correct.

As previously explained, FIG. 11 illustrates a flowchart of the vent process performed by the control panel 500 and the components in the outlet cabinet 300 of the gas cylinder holder 10. Thus, the flowchart illustrated in FIG. 11 is an expansion of step S115 shown in the flowchart of FIG. 10. At S200, and as previously explained, after the operator receives an indication from the control panel 500 that the gas cylinder A is empty or close to empty, and after the control panel 500 has switched to supply gas from the gas cylinder B instead of the gas cylinder A, the operator initiates the vent process or vent sequence via the control panel 500. At S205, the control panel 500 presents a first prompt to the operator via the display 510. The first prompt may request that the operator verify that the valve at gas cylinder A has been shut, and monitors for receipt of an input from the operator in response to the first prompt. Thus, the control panel 500 requests that the operator verify once the valve on the top of the gas cylinder A has been hand tightened. At S210, the control panel determines whether or not the operator verified that the valve on the gas cylinder A has been shut (i.e., the control panel 500 determines whether or not it received an input from the operator in response to the first prompt). If the operator did not verify that the valve has been shut, then the process returns to S205, where the control panel 500 continues to monitor whether or not the operator has verified that the valve on the gas cylinder A has been shut.

However, if, at S210, the operator did verify to the control panel 500 that the valve on the gas cylinder A has been shut, then, at S215, the control panel presents a second prompt to the operator via the display 510. The second prompt may request that the operator verify whether or not the gas cylinder A has been vented, and then monitor for receipt of an input from the operator in response to the second prompt. At S220, the control panel 500 determines whether or not the operator verified that the gas cylinder A has been vented (i.e., the control panel 500 determines whether or not it received an input from the operator in response to the second prompt). If the operator did verify that the gas cylinder A has been vented already, then the vent process ends. However, if, at S220, the operator verified that the gas cylinder A has not been vented yet, then, at S225, the control presents a third prompt via the display 510. The third prompt may request that the operator verify whether or not the operator is ready to vent the connection lines of the outlet cabinet 300 that are connected to the gas cylinder A, and monitors for receipt of an input from the operator in response to the third prompt.

At S230, the control panel 500 determines whether or not the operator verified that the operator is ready to vent the connection lines that are connected to the gas cylinder A (i.e., the control panel 500 determines whether or not it received an input from the operator in response to the third prompt). If the operator did not verify that the operator is ready to vent the connection lines, then the process returns to S225, where the control panel 500 continues to monitor whether or not the operator has verified that the operator is ready to vent the connection lines. However, if, at S230, the control panel 500 receives an input from the operator that verifies that that operator is ready to vent the connection lines, then, at S235, the control panel 500 shuts off the valve (e.g., the second solenoid valve) of the supply lines from the gas cylinder B.

At S240, the control panel 500 reopens the valve (e.g., the first solenoid valve) of the supply lines from the gas cylinder A in order to vent the remaining gas from the supply lines. With the valve of the supply lines from the gas cylinder A open, at S245, the control panel 500 then monitors the pressure of the supply lines from the gas cylinder A via the one or more sensors in the outlet cabinet 300 to determine whether or not the pressure in the supply lines has reached a predetermined pressure (e.g., approximately 4.0 bar or approximately 58 psi).

At S250, the control panel 500 then determines whether or not the pressure in the supply lines of the gas cylinder A has reached the predetermined pressure. If the pressure in the supply lines from the gas cylinder A has not reached the predetermined pressure, then the process returns to S245 and the pressure in the supply lines continues to be monitored. However, if, at S250, the control panel 500 determines that the pressure in the supply lines from the gas cylinder A has reached the predetermined pressure, then, at S255, the control panel 500 shuts the valve of the supply lines from the gas cylinder A. The control panel 500 then, at S260, reopens the valve of the supply lines from the gas cylinder B and restarts supplying gas from the gas cylinder B, which completes the vent process of the supply lines from gas cylinder A.

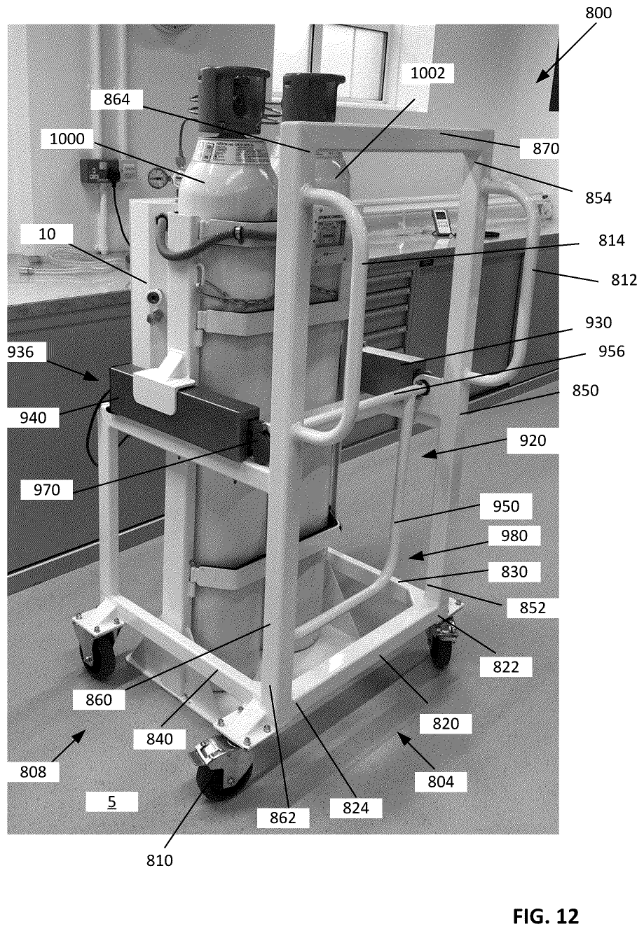

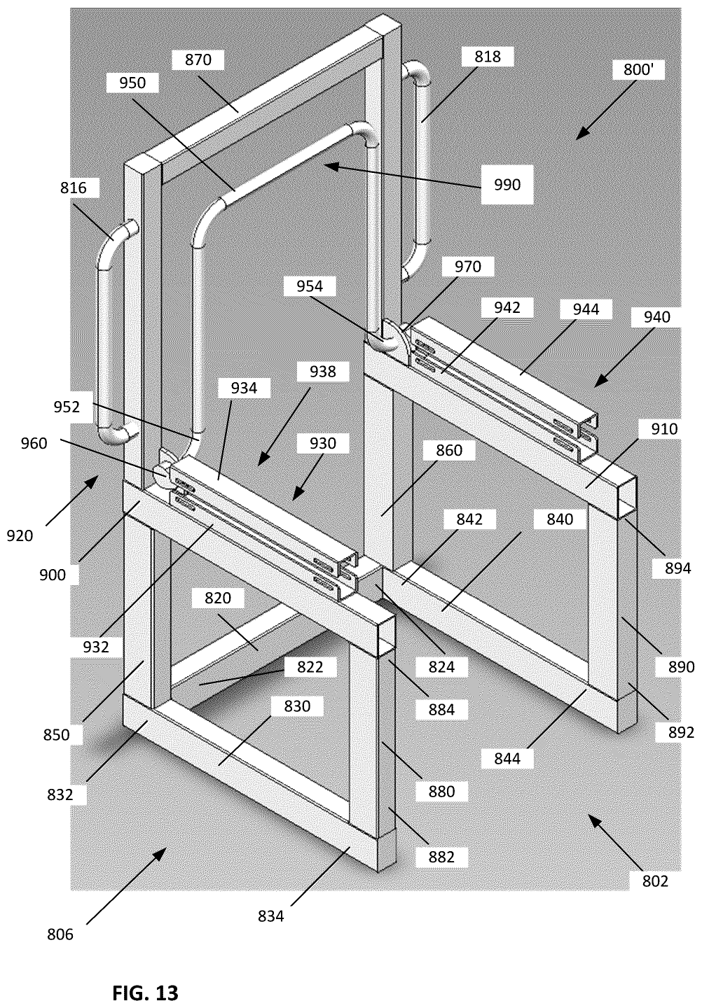

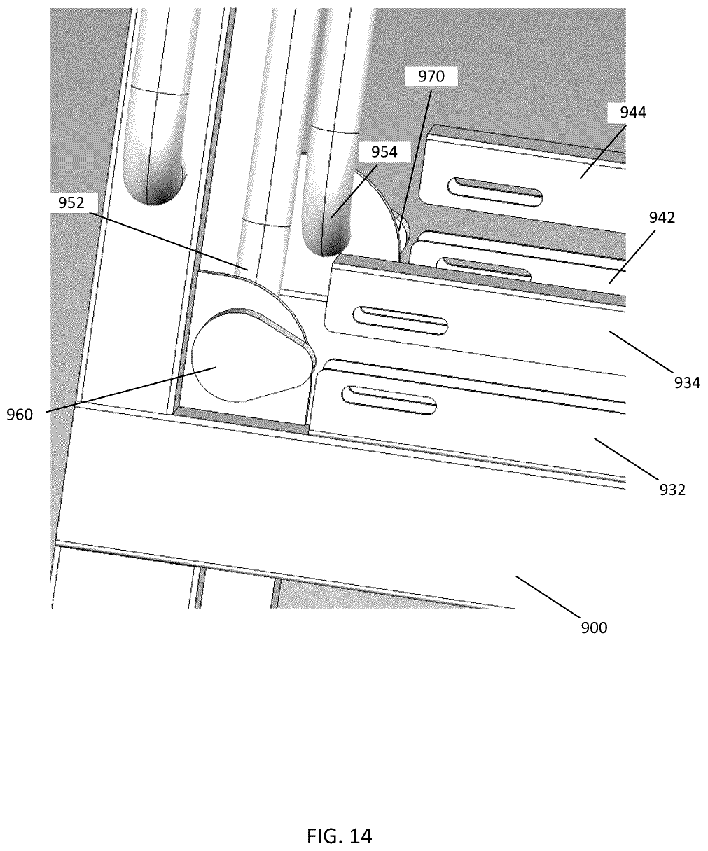

Turning to FIGS. 12-14, illustrated is a cart 800 configured to lift the gas cylinder holder 10 off the ground 5, and facilitate the movement of the gas cylinder holder 10 regardless of whether or not gas cylinders are stored in the storage region of the gas cylinder cart 800. Cart 800 is illustrated in FIG. 12 and a similarly structured cart 800′ is illustrated in FIGS. 13 and 14. The cart 800, as illustrated, may have a substantially square cross-sectional shape with a front side 802, opposite rear side 804, first side 806 spanning from the front side 802 to the rear side 804, and a second side 808 opposite the first side 806, the second side 808 also spanning from the front side 802 to the rear side 804.

The cart 800 may include a series of lower frame members that are oriented substantially horizontally. The lower frame members can be collectively referred to as a lower frame. More specifically, the cart 800 may include a rear lower frame member 820 disposed on the rear side 804 of the cart 800, a first side lower frame member 830 disposed on the first side 806 of the cart 800, and a second side lower frame member 840 disposed on the second side 808 of the cart 800. The first side lower frame member 830 may extend laterally from a first end 822 of the rear lower frame member 820, while the second side lower frame member 840 may extend laterally from a second end 824 of the rear lower frame member 820. Thus, the first ends 832 and 842 of the first and second side lower frame members 830 and 840 are coupled to the first and second ends 822 and 824, respectively, of the rear lower frame member 820. The first side lower frame member 830 and the second side lower frame member 840 may extend in the same direction from the rear lower frame member 820, may be spaced from one another, and may be substantially parallel to one another. As illustrated, a lower frame member does not extend across the front side 802 of the cart 800 between the second ends 834 and 844 of the first and second side lower frame members 830 and 840.

As further illustrated, the cart 800 includes two upstanding rear frame members 850 and 860 that extend vertically from the rear lower frame member 820. The first upstanding rear frame member 850 may extend vertically from a first end 822 of the rear lower frame member 820 (i.e., proximate to the coupling of the first side lower frame member 830 to the rear lower frame member 820), while the second upstanding rear frame member 860 may extend vertically from a second end 824 of the rear lower frame member 820 (i.e., proximate to the coupling of the second side lower frame member 840 to the rear lower frame member 820). Thus, the first ends 852 and 862 of the first and second upstanding rearward frame members 850 and 860 are coupled to the first and second ends 822 and 824, respectively, of the rear lower frame member 820.

The first upstanding rear frame member 850 and the second upstanding rear frame member 860 may extend in the same vertical direction from the rear lower frame member 820, may be spaced from one another, and may be substantially parallel to one another. A rear upper frame member 870 may be disposed between, and coupled to, the second ends 854 and 864 of the two upstanding rear frame members 850 and 860. Thus, the rear upper frame member 870 may be oriented parallel to, disposed over, but spaced from, the rear lower frame member 820.

The cart 800 may further include a first upstanding front frame member 880 extending vertically from the second end 834 of the first side lower frame member 830 and a second upstanding front frame member 890 extending vertically from the second end 844 of the second side lower frame member 840. A first end 882 of the first upstanding front frame member 880 may be coupled to the second end 834 of the first side lower frame member 830, while a first end 892 of the second upstanding front frame member 890 may be coupled to the second end 844 of the second side lower frame member 840. Thus, the first and second upstanding front frame members 880 and 890 may be spaced from, and oriented substantially parallel to, one another. Moreover, the first and second upstanding front frame members 880 and 890 may also be spaced from, and oriented substantially parallel to, the first and second upstanding rear frame members 850 and 860. As best illustrated in FIGS. 12 and 13, the first and second upstanding front frame members 880 and 890 may be shorter in height than the first and second upstanding rear frame members 850 and 860.

As further illustrated, a first side upper frame member 900 may extend from the second end 884 of the first upstanding front frame member 880 toward the first upstanding rear frame member 850. The first side upper frame member 900 may extend substantially horizontal from the second end 884 of the first upstanding front frame member 880 such that the first side upper frame member 900 may be substantially parallel to the first side lower frame member 830. Because the first upstanding front frame member 880 is shorter in length (i.e., height) than the first upstanding rear frame member 850, and because the first side upper frame member 900 is substantially horizontal, the first side upper frame member 900 may be connected to the first upstanding rear frame member 850 at a location between the first end 852 and the second end 854 of the first upstanding rear frame member 850.

Similar to the first side upper frame member 900, a second side upper frame member 910 may extend from the second end 894 of the second upstanding front frame member 890 toward the second upstanding rear frame member 860. The second side upper frame member 910 may extend substantially horizontal from the second end 894 of the second upstanding front frame member 890 such that the second side upper frame member 910 may be substantially parallel to the second side lower frame member 840. Because the second upstanding front frame member 890 is shorter in length (i.e., height) than the second upstanding rear frame member 860, and because the second side upper frame member 910 is substantially horizontal, the second side upper frame member 910 may be connected to the second upstanding rear frame member 860 at a location between the first end 862 and the second end 864 of the second upstanding rear frame member 860. Moreover, as illustrated, the second side upper frame member 910 may be vertically aligned with the first side upper frame member 900, while also being spaced from and oriented substantially parallel to the first side upper frame member 900.

The cart 800, as illustrated and described herein, does not contain any frame members that extend across the front side 802 of the cart 800. Thus, when viewed from the top looking downward, the frame members of the cart 800 may form a substantially U-shape. The frame members may collectively define a receiving area of the cart 800, the receiving area being the area into which the gas cylinder holder 10 may be slid to facilitate lifting and then moving of the gas cylinder holder 10. Because the front side 802 of the cart 800 does not contain any frame members that extend across the front side 802 of the cart 800, the front side 802 of the cart 800 provides the access opening for the receiving area of the cart 800.

The cart 800 may further include a series of wheels or casters 810 that are coupled to the bottom of the cart 800 (see FIG. 12). The wheels or casters can be referred to alternatively as mobility devices, and as described herein, are coupled to the lower frame. More specifically, a caster 810 may be coupled to the second end 834 of the first side lower frame member 830, the second end 844 of the second side lower frame member 840, and the first and second ends 822 and 824 of the rear lower frame member 820 (i.e., the coupling of the first side lower frame member 830 to the rear lower frame member 820 and the coupling of the second side lower frame member 840 to the rear lower frame member 820). The casters 810 facilitate case of movement of the cart 800 over a support surface 5.

As shown in FIG. 12, the cart 800 may also include a series of handles 812 and 814 disposed on, or coupled to, the first and second upstanding rear frame members 850 and 860. The handles 812 and 814 may be disposed on the first and second upstanding rear frame members 850 and 860 more proximate to the second ends 854 and 864 of the first and second upstanding rear frame members 850 and 860 than the first ends 852 and 862 of the first and second upstanding rear frame members 850 and 860. The handles 812 and 814 enable an operator of the cart 800 to more easily control movement of the cart 800 over a support surface 5 by providing an easily graspable portion of the cart 800. The handles 812 and 814 may be positioned on the first and second upstanding rear frame members 850 and 860 such that, when grasped by an operator, the operator can more easily push and/or pull the cart 800. In different embodiments, the size and orientation of the handles can vary. Referring to FIG. 13, an alternative embodiment of a cart 800′ with handles 816 and 818 coupled thereto in different orientations is illustrated.

As further illustrated in FIGS. 12 and 13, each of the cart 800 and cart 800′ may be equipped with a lifting mechanism 920. In FIG. 12, the cart 800 includes a lifting mechanism 920 that may include lifting devices 930 and 940 disposed on the first side upper frame member 900 and the second side upper frame member 910, respectively, as well as an actuator or lifting handle 950 that is configured to actuate both lifting devices 930 and 940 simultaneously. The lifting device 930 disposed on the first side upper frame member 900 may be substantially similar to the lifting device 940 disposed on the second side upper frame member 910. Thus, the description of one lifting device may apply to both of the lifting devices.

As illustrated, the lifting devices 930 and 940 may be scissor lifts, where each of the lifting devices 930 and 940 includes a lower component 932 and 942 and an upper component 934 and 944 (see FIG. 13) connected by scissor lift arms. The lower component 932 of the lifting device 930 may be coupled to the first or second side upper frame member 900 or 910 of the cart 800. The upper component 934 may be movably coupled to the lower component 932 such that the upper component 934 may be capable of translating vertically between a lowered position 936 (best shown in FIG. 12) and a raised position 938 (best shown in FIGS. 13 and 14). While not shown, the upper component 934 may be movably coupled to the lower component 932 via a pair of linked folding support arms that are oriented in a crisscross or X-shaped pattern. The ends of the support arms may be linked within a track to each of the upper component 934 and the lower component 932. In operation, the upper component 934 may be raised with respect to the lower component 932 by applying a pressure or a force one or more of the support arms at one end of the lifting device or mechanism 920, which causes the crisscrossing support arms to elongate in the vertical direction (i.e., by the ends of one support arm moving closer to the ends of the other support arm).

The actuator 950 of the lifting mechanism 920 may be configured to apply an equal pressure or an equal amount of force to both lifting devices 930 and 940 simultaneously. As best illustrated in FIGS. 12 and 13, the actuator may be a substantially U-shaped arm that is disposed between the first and second upstanding rear frame members 850 and 860 of the cart 800. The first end 952 of the actuator 950 may be rotatably coupled to the first side upper frame member 900 at a location proximate to the coupling of the first side upper frame member 900 to the first upstanding rear frame member 850. As further illustrated, the first end 952 of the actuator 950 may be disposed between the lifting device 930 coupled to the first side upper frame member 900 and the first upstanding rear frame member 850. The second end 954 of the actuator 950 may be rotatably coupled to the second side upper frame member 910 at a location proximate to the coupling of the second side upper frame member 910 to the second upstanding rear frame member 860. As further illustrated, the second end 954 of the actuator 950 may be disposed between the lifting device 940 coupled to the second side upper frame member 910 and the second upstanding rear frame member 910. As illustrated in FIGS. 13 and 14, each of the first end 952 and the second end 954 of the actuator 950 may include a cam 960 and 970 that, depending on the orientation of the actuator 950, may engage one or more ends of the support arms of the lifting devices 930 and 940 to apply a pressure or a force onto the support arms of the lifting devices 930 and 940 to translate the upper components 934 and 944 from their lowered positions 936 to their upper positions 938. The actuator is shown in the lowered position in FIG. 12, where the cams 960 and 970 of the ends of the actuator 950 are not applying a pressure or force to the support arms of the lifting devices 930 and 940. Thus, as shown in FIG. 12, the upper components 934 and 944 of the lifting devices 930 and 940 are in their lowered positions 936. However, as shown in FIGS. 13 and 14, the actuator 950 has been rotated about a horizontal axis extending through the ends 952 and 954 of the actuator 950 from the lowered or lifting position 980 to the raised or lowering position 990. As an operator rotates the actuator 950 from the lowered position 980 (best shown in FIG. 12) to the raised position 990 (best shown in FIGS. 13 and 14), the cams 960 and 970 of the ends 952 and 954 of the actuator 950 are rotated into engagement with the support arms of the lifting devices 930 and 940. Continued rotation of the actuator 950 to the raised position 990 causes the cams 960 and 970 to apply a force to the support arms of the lifting devices 930 and 940, which, in turn, causes the upper components 934 and 944 to be translated to their raised positions 938 where the upper components 934 are spaced from the lower components 932.

In some embodiments, the actuator 950 may further include a crossbeam 956 that extends horizontally from the first end 952 to the second end 954 (as best illustrated in FIG. 12). The components of the gas cylinder cart above the lower frame can be referred to collectively as the upper frame.

As best illustrated in FIG. 12, and as previously explained, the cart 800 is configured to engage a gas cylinder holder 10 to lift the gas cylinder holder 10 above the support surface 5, and move the gas cylinder holder 10 over the support surface 5 once lifted. In order to lift and move a gas cylinder holder 10, an operator may move the cart 800 to be in proximity to a gas cylinder holder 10. Once in proximity, the operator may align the cart 800 with the gas cylinder holder 10 such that the front side 12 or rear side 14 of the gas cylinder holder 10 is disposed proximate to the front end or side 802 of the cart 800. In other words, the operator aligns the opening of the receiving area of the cart 800 with the front side 12 or rear side 14 of the gas cylinder holder 10. When aligning the cart 800 with the gas cylinder holder 10, the operator may further align the lifting devices 930 and 940 disposed on the first and second side upper frame members 900 and 910 with the receiving regions 105 and 135 of the first and second engagement members 100 and 130, respectively. Once aligned, the operator may move the cart 800 toward the gas cylinder holder 10 such that the gas cylinder holder 10 is inserted into the receiving area of the cart 800 via the opening on the front side 802, and such that the lifting devices 930 and 940 of the cart 800 are simultaneously inserted into the receiving regions 105 and 135 of the first and second engagement members 100 and 130 of the gas cylinder holder 10. Once the receiving regions 105 and 135 of the first and second engagement members 100 and 130 of the gas cylinder holder 10 have slid entirely past the leading end of the lifting devices 930 and 940 of the cart 800, the operator may then rotate the actuator 950 from the lowered position 980 to the raised position 990. As explained previously, rotation of the actuator 950 from the lowered position 980 to the raised position 990 causes the cams 960 and 970 disposed on the ends 952 and 954 of the actuator 950 to engage the support arms of the lifting devices 930 and 940 to cause the upper components 934 and 944 of the lifting devices 930 and 940 to move upward away from the lower components 932 and 942 (e.g., causes the upper components 934 and 944 of the lifting devices 930 and 940 to move from their lowered positions 936 to their raised positions 938). When the upper components 934 and 944 of the lifting devices 930 and 940 are raised to their raised positions 938, the upper components 934 and 944 of the lifting devices 930 and 940 engage and push upwardly on the first and second engagement members 100 and 130, respectively, of the gas cylinder holder 10 in order to lift the gas cylinder holder 10 off of the support surface 5. With the upper components 934 and 944 of the lifting devices 930 and 940 in their raised positions 938, and with the gas cylinder holder 10 suspended above the support surface 5, the operator is able to move the gas cylinder holder 10 across a support surface 5 via the cart 800. The cart 800, as described herein, may be configured to lift and move the gas cylinder holder 10 regardless of whether or not gas cylinders 1000 and 1002 are disposed within the storage region of the gas cylinder holder 10. In order to lower and disengage the gas cylinder holder 10 from the cart 800 (i.e., to place the gas cylinder holder 10 in a location), the operator, once the gas cylinder holder 10 is located in its desired location, may perform the above mentioned steps in reverse order. Thus, the cart 800, as described herein, enable the gas cylinder holder 10, and any gas cylinders disposed therein, to be easily relocated to any location as needed or desired.

While the apparatuses presented herein have been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. For example, the gas cylinder holder/frame presented herein may be modified to be of any shape, and contain any number of frame members, doors, outlet panels, outlet panel components, latch mechanisms, control panels, etc. . . . Moreover, the cart presented herein may also be of any shape, may contain any number of frame members, may contain any number of lifting devices, and may utilize any type of lifting mechanism/device.

In addition, various features from one of the embodiments may be incorporated into another of the embodiments. That is, it is believed that the disclosure set forth above encompasses multiple distinct inventions with independent utility. While each of these inventions has been disclosed in a preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention. Additionally, it is also to be understood that the frame members of the gas cylinder holder described herein, the frame members of the cart described herein, the components of the outlet panel described herein, the control panel described herein, or portions of any thereof may be fabricated from any suitable material or combination of materials, such as, but not limited to, plastic or metals (e.g., nickel, copper, bronze, aluminum, steel, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about”, “around”, “generally”, and “substantially.”

What is claimed:

1. A gas cylinder system comprising:
a gas cylinder holder that includes:
a base frame member on which a gas cylinder can be placed;
a first upstanding frame member coupled to a first side of the base frame member, the first upstanding frame member having a first engagement member extending outwardly from the first upstanding frame member and defining a first receiving region with the first upstanding frame member, the first upstanding frame member including a plurality of hinge members spaced apart vertically from each other;
a second upstanding frame member coupled to a second side of the base frame member, the second side of the base frame member being opposite the first side of the base frame member, the second upstanding frame member having a second engagement member extending outwardly from the second upstanding frame member and defining a second receiving region with the second upstanding frame member, the second engagement member extending in a direction opposite to the direction of the first engagement member;
a first rear horizontal member extending from the first upstanding frame member to the second upstanding frame member;
a second rear horizontal member extending from the first upstanding frame member to the second upstanding frame member;
an electronic component coupled to one of the first rear horizontal member and the second rear horizontal member; and
a door rotatably mounted to the first upstanding frame member, the door including:
a first front horizontal member having a hinge member coupled to one of the plurality of hinge members on the first upstanding frame member;
a second front horizontal member spaced apart from and parallel to the first front horizontal member;
a third front horizontal member being spaced apart from and parallel to the second front horizontal member, the third front horizontal member having a hinge member coupled to a different one of the plurality of hinge members on the first upstanding frame member;
a front vertical member coupled to two of the front horizontal members; and
a control panel coupled to one of the horizontal members or the vertical members of the door, wherein the door pivots between an opened position and a closed position about an axis passing through each of the hinge members.

2. The gas cylinder system of claim 1, wherein the first engagement member includes a horizontal member and a vertical member coupled to the horizontal member of the first engagement member, and the vertical member and the horizontal member of the first engagement member collectively define the first receiving region with the first upstanding frame member.

3. The gas cylinder system of claim 1, wherein the base frame member, the first upstanding frame member, the second upstanding frame member, the first rear horizontal member, the second rear horizontal member, and the door collectively define a storage region in which one or more gas cylinders can be placed.

4. The gas cylinder system of claim 3, wherein each of the electronic component and the control panel can be used in the operation of a gas cylinder placed in the storage region.

5. The gas cylinder system of claim 1, further comprising:
a gas cylinder placed on the base frame member, wherein the upstanding frame members are located on opposite sides of the gas cylinder, the rear horizontal members are located on a rear side of the gas cylinder, and the door is located on a front side of the gas cylinder.

6. The gas cylinder system of claim 5, further comprising:
a tether having a first end and a second end opposite the first end, wherein the first end of the tether is coupled to the first rear horizontal member, the second end of the tether is coupled to the first upstanding frame member, and the tether extends around a portion of the gas cylinder.

7. The gas cylinder system of claim 6, wherein the first end of the tether is fixedly coupled to the first rear horizontal member, and the second end of the tether is releasably coupled to the first upstanding frame member.

8. The gas cylinder system of claim 5, wherein the first receiving region is configured to receive a first lift arm on a gas cylinder cart, the second receiving region is configured to receive a second lift arm on the gas cylinder cart, and the gas cylinder holder can be lifted so that the base frame member is raised off a support surface when the first lift arm and the second lift arm move the first receiving region and the second receiving region upwardly respectively.

9. The gas cylinder system of claim 1, wherein the second upstanding frame member includes a first latch mechanism, and the first front horizontal member includes a second latch mechanism that is engageable with the first latch mechanism to retain the door in its closed position.

10. The gas cylinder system of claim 1, wherein the electronic component is mounted to the first rear horizontal member and to the second rear horizontal member, and the control panel is mounted to the first front horizontal member.

11. A gas cylinder cart comprising:
a movable frame comprising:
a lower frame including a plurality of mobility devices coupled thereto;
a first upstanding rear frame member coupled to and extending upwardly from the lower frame;
a second upstanding rear frame member coupled to and extending upwardly from the lower frame;
a first side upper frame member coupled to and extending from the first upstanding rear frame member; and
a second side upper frame member coupled to and extending from the second upstanding rear frame member; and
a lifting mechanism coupled to the movable frame, the lifting mechanism comprising:
a first lifting device including a first lower component and a first upper component coupled to and movable relative to the first lower component, the first upper component being configured to engage a first receiving region on a gas cylinder holder;
a second lifting device including a second lower component and a second upper component coupled to and movable relative to the second lower component, the second upper component being configured to engage a second receiving region on the gas cylinder holder; and
an actuator pivotally coupled to the movable frame, wherein the actuator is engageable with each of the first lifting device and the second lifting device, and the actuator is movable between a lowering position and a lifting position.

12. The gas cylinder cart of claim 11, wherein the lower frame comprises a rear lower frame member, a first side lower frame member coupled to the rear lower frame member, and a second side lower frame member coupled to the rear lower frame member, and each of the plurality of mobility devices is coupled proximate to one of the rear lower frame member, the first side lower frame member, and the second side lower frame member.

13. The gas cylinder cart of claim 11, wherein the actuator has a first actuator end and a second actuator end opposite to the first actuator end, each of the first actuator end and the second actuator end is coupled to the movable frame, the first actuator end has a first cam member coupled thereto that is engageable with the first lifting device, and the second actuator end has a second cam member coupled thereto that is engageable with the second lifting device.

14. The gas cylinder cart of claim 13, wherein the first lifting device includes a lower component and an upper component that moves relative to the lower component between a lowered position and a raised position, and the second lifting device includes its own lower component and its own upper component that moves relative to its lower component between its own lowered position and its own raised position, the first cam member causes the first lifting device upper component to move between its lowered position and its raised position, and the second cam member causes the second lifting device upper component to move between its lowered position and its raised position.

15. The gas cylinder cart of claim 11, wherein the movable frame includes a first handle coupled to the first upstanding rear frame member and a second handle coupled to the second upstanding rear frame member, and the handle can be used to move the movable frame on the mobility devices along a support surface.

16. A gas cylinder system comprising:
a gas cylinder;
a gas cylinder holder configured to receive and support the gas cylinder, the gas cylinder holder comprising:
a base frame member;
a plurality of upstanding frame members coupled to the base frame member, each of the plurality of upstanding frame members having an engagement member defining a receiving region;
a rear horizontal member extending between the plurality of upstanding frame members;
a control cabinet coupled to the rear horizontal member and connectable with the gas cylinder; and
a door coupled to one of the upstanding frame members, the door being rotatable between an opened position and a closed position, the door, the base frame member, the plurality of upstanding frame members, and the rear horizontal member collectively defining an area in which the gas cylinder can be located; and
a gas cylinder cart comprising:
a lower frame including a plurality of mobility devices coupled thereto, the plurality of mobility devices being translatable across a support surface;
an upper frame mounted to the lower frame, the upper frame including a plurality of upstanding rear frame members coupled to the lower frame, and a plurality of side upper frame members, each of the plurality of side upper frame members is coupled to one of the plurality of upstanding rear frame members; and
a lifting mechanism coupled to the upper frame, the lifting mechanism being configured to engage the receiving region of each of the plurality of upstanding frame members, the lifting mechanism including an actuator that can be moved between a lifting position and a lowered position, the actuator causing the lifting mechanism to raise the gas cylinder holder and the gas cylinder when the actuator is moved to its lifting position.

17. The gas cylinder system of claim 16, wherein the lifting mechanism includes a first lifting device on a first side of the upper frame and a second lifting device on a second side of the upper frame, the actuator is engageable with the first lifting device and with the second lifting device to move them between lowered positions and raised positions, and the gas cylinder holder and the gas cylinder are raised off a support surface when the first lifting device and the second lifting device are engaged with the receiving regions and are in their raised positions.

18. The gas cylinder system of claim 17, wherein the plurality of upstanding frame members includes a first upstanding frame member and a second upstanding frame member, the engagement member of the first upstanding frame member extends outwardly in a first direction, the engagement member of the second upstanding frame member extends outwardly in a second direction, and the second direction being opposite to the first direction.

19. The gas cylinder system of claim 18, wherein the gas cylinder is a first gas cylinder, the gas cylinder system further comprises a second gas cylinder, and the gas cylinder holder further comprises:
a first tether coupled to the rear horizontal member, extending around the first gas cylinder, and being releasably coupled to the first upstanding frame member; and
a second tether coupled to the rear horizontal member, extending around the second gas cylinder, and being releasably coupled to the second upstanding frame member.

20. The gas cylinder system of claim 16, wherein the door includes a first front horizontal member, a second front horizontal member spaced apart from and parallel to the first front horizontal member, a third front horizontal member spaced apart from and parallel to the second front horizontal member, a first front vertical member coupled to the first front horizontal member and to the second front horizontal member, a second front vertical member coupled to the second front horizontal member and to the third front horizontal member, and a control panel coupled to one of the horizontal members or the vertical members of the door.
